(19) United States
(12) Patent Application Publication
(10) Pub. No.: US 2010/0064431 A1
(43) Pub. Date: Mar. 18, 2010

(54) TRANSFER ASSIST DEVICE AND TRANSFER ASSIST DEVICE WITH MULTI-SUPPORTER MECHANISM

(76) Inventors: Hideo Kawakami, Osaka (JP); Yohei Kume, Osaka (JP); Tohru Nakamura, Osaka (JP); Soichiro Fujioka, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/516,676

(22) PCT Filed: Mar. 26, 2008
(86) PCT No.: PCT/JP2008/000737

§ 371 Date: May 28, 2009

(30) Foreign Application Priority Data
Mar. 28, 2007 (JP) 2007-083718
Sep. 7, 2007 (JP) 2007-232328

(51) Int. Cl. A61G 7/14; A61G 7/10

(52) U.S. Cl. 5/81.1 RP

(57) ABSTRACT

The transfer assist device has a supporter for lifting a human body placed on the placement base, joint portions for changing the posture of the supporter landing sensors for detecting whether the lower surface of the supporter has landed onto a placement surface, a leg portion for moving the supporter up and down, and a control section for controlling pivotal movements of the joint portions or an elevating movement of the leg portion based on outputs from the landing sensors. The control section is operable to move at least one of the joint portions and the leg portion so as to define and hold at least one of a parallel state and an adjusted state between the placement surface of the placement base and the lower surface of the supporter, based on the outputs from the landing sensors.

### TECHNICAL FIELD

The present invention relates to a transfer assist device for assisting an operation of transferring a person from one place to another place in a hospital, at home, or in a like facility, and more particularly to a transfer assist device, and a transfer assist device with a multi-supporter mechanism operable to lift and transfer a person (hereinafter, referred to as a “cared person”) to be cared such as an elderly person, a sick person, or an injured person who is placed on a placement device such as a wheelchair, a bed, or a stretcher.

### BACKGROUND ART

In a hospital, at home, or in a like facility, conventionally, family members, professional staffs, or a like human power mainly perform nursing care for persons having difficulty in walking/moving, or bedridden persons. In this occasion, the work load of carers is heavy, and various problems including difficulty in securing a sufficient number of carers, and care costs may occur. Nowadays, the aging of society progresses, and the aforementioned problems are becoming important social issues.

There are proposed a transfer assist device for assisting transfer of a bedridden patient, and a nursing assistant robot for use in bathing (see e.g. patent documents 1 and 2).

Patent document 1 discloses an arrangement that: three transfer plates for supporting the upper body, the waist, and the legs of a patient respectively are movable in forward and backward directions in alignment with the upper surface of a bed; and a carer manipulates the three transfer plates to transfer the whole body of the patient to and from the bed without imposing burden to the patient. The transfer assist device disclosed in patent document 1 is provided with force detectors and limit switches to control an assisting operation of the transfer assist device by detecting the positions and operating forces of the transfer plates.

Patent document 2 discloses a nursing assistant robot for use in bathing. The nursing assistant robot is provided with water level sensors for two support plates (one for the upper body and the other for the lower body), respectively, and a bather is allowed to bathe in a state that the posture and the bathing depth of the bather are controlled.

Patent document 1: JP Hei 8-16850A

Patent document 2: JP Hei 6-9588B

The conventional transfer assist devices are devices for detecting a horizontal level such as the surface of a fixed-type bed or the water level of a bathtub, and a function of controlling an object having a detection surface of a complicated shape including a slope is not provided. In recent years, a reclining bed capable of adjusting the tilt of a backrest has been spread as a bed for a cared person to be used in a hospital or at home. The conventional transfer assist devices could not be used in transferring a cared person to and from a reclining bed or a like placement base.

In particular, in the case where a placement surface of a bed where a cared person is placed is not in a horizontal position, i.e., the backrest is upright, it is required to make the tilt of a supporter for supporting a cared person substantially equal to the tilt of the upper surface of the bed, and lift the cared person in a state that the supporter is contacted with the bed. In this arrangement, the carer has difficulty in manually adjusting the position and the tilt angle of the supporter with respect to the tilt of the placement surface.

### DISCLOSURE OF THE INVENTION

In view of the above, it is an object of the invention to provide a transfer assist device, and a transfer assist device with a multi-supporter mechanism capable of allowing a carer to smoothly lift and transfer a cared person from a placement base, even if the tilt of a placement surface of the placement base where the cared person is placed is not horizontal.

In order to attain the above object, a transfer assist device of the invention includes: a supporter operable to be inserted between a placement surface of a placement base and a human body placed on the placement surface, and lift the human body; one or more pivot means for performing at least one of changing and adjusting a posture of the supporter; multiple landing detecting means for detecting whether a lower surface of the supporter has landed onto an upper surface of the placement surface; elevating means for moving the supporter up and down; and control means for controlling the pivot means or the elevating means to define and hold at least one of a parallel state and an adjusted state between the placement surface and the supporter, based on outputs from the multiple landing detecting means.

### BRIEF DESCRIPTION OF THE DRAWINGS

FIG. 1 is a perspective view showing a state of use of a transfer assist device in accordance with the first embodiment of the invention.

FIGS. 2A and 2B are side views showing use examples of a placement base on which a cared person is placed in using the transfer assist device.

FIG. 3 is a perspective view showing a structure of essential parts of the transfer assist device.

FIG. 4 is a side view showing a structure of a supporter of the transfer assist device.

FIG. 5 is a partially enlarged view showing a structure of landing detecting means of the transfer assist device.

FIG. 6 is a perspective view showing a structure of notice means of the transfer assist device.

FIG. 7 is a block diagram showing an electrical configuration of the transfer assist device.

FIG. 8 is a diagram for describing a control system of the transfer assist device.

FIG. 9 is a flowchart for describing an operation to be performed by the transfer assist device.

FIGS. 10A through 10D are plan views showing arrangement examples of the landing detecting means of the transfer assist device.

FIG. 11 is a diagram showing an example of a wheelchair for use with a transfer assist device in accordance with the second embodiment of the invention.

FIGS. 12A through 12C are diagrams showing a structure example of a supporter of the transfer assist device in accordance with the second embodiment.

FIGS. 13A through 13E are diagrams for describing an operation of using the supporter of the transfer assist device in accordance with the second embodiment.

FIGS. 14A and 14B are diagrams showing examples of using the supporter of the transfer assist device in accordance with the second embodiment.

FIG. 15 is a perspective view showing a basic arrangement of a transfer assist device in accordance with the third embodiment of the invention.

FIGS. 16A and 16B are diagrams for describing an application example of a structure of a supporter of a transfer assist device in accordance with the fourth embodiment of the invention.

FIGS. 17A and 17B are diagrams for describing an application example of a structure of a supporter of a transfer assist device in accordance with the fifth embodiment of the invention.

FIGS. 18A and 18B are diagrams for describing another application example of the structure of the supporter of the transfer assist device in accordance with the fifth embodiment of the invention.

FIG. 19 is a side view for describing an application example of a structure of a supporter of a transfer assist device in accordance with the sixth embodiment of the invention.

FIG. 20 is a front view showing a structure example of a wheel of a transfer assist device in accordance with the seventh embodiment of the invention.

FIG. 21 is a diagram for describing an arrangement example of a display section of a transfer assist device in accordance with the eighth embodiment of the invention.

### BEST MODE FOR CARRYING OUT THE INVENTION

In the following, preferred embodiments for carrying out the invention are described referring to the drawings.

### First Embodiment

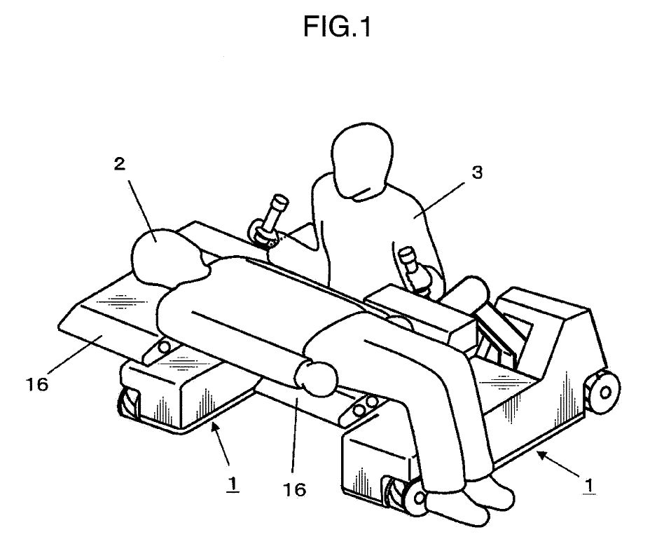

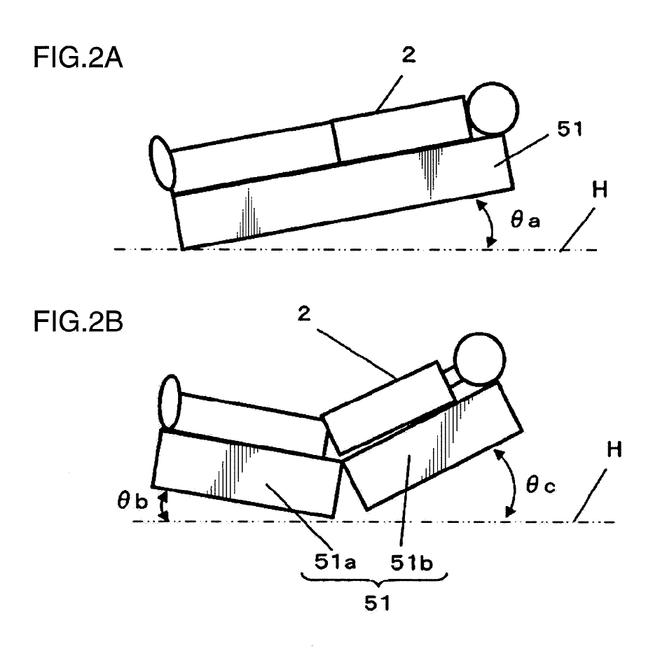

First, briefly described is an arrangement as to how a carer 3 provides nursing care for a cared person 2 by using a transfer assist device 1 of the first embodiment of the invention, referring to FIGS. 1 through 2B. FIG. 1 is a perspective view showing a state of use of the transfer assist device 1 in accordance with the first embodiment of the invention. FIGS. 2A and 2B are side views showing use examples of a placement base on which the cared person 2 is placed in using the transfer assist device 1 in accordance with the first embodiment

The transfer assist device 1 is mainly used to transfer the cared person 2 to another placement base by: inserting a supporter 16 between the cared person 2 placed on a placement base, and the placement base; and lifting the cared person 2 on a lifting surface of the supporter 16.

FIG. 1 is a diagram showing a state that the carer 3 manipulates two transfer assist devices 1 with respect to a placement base (e.g. a bed) on which the cared person 2 is placed to lift and hold the cared person 2 by two supporters 16. In an ordinary case, the placement base is used in a horizontal state. In the first embodiment, the transfer assist device 1 is compatible with a placement base in different use states.

FIG. 2A shows an example, wherein the cared person 2 is placed on a placement base 51 with a tilt angle θa with respect to a horizontal plane H.

In the above condition, the carer 3 manipulates the transfer assist devices 1 to move the supporters 16 toward the placement base 51, detect a degree of parallelism between the placement surface of the placement base 51 and the lower surfaces of the supporters 16, and adjust the tilt angles of the supporters 16. Next, the carer 3 manipulates the transfer assist devices 1 to insert the supporters 16 between the cared person 2 and the placement surface of the placement base 51, and lift the cared person 2 on lifting surfaces of the supporters 16. Thereby, the carer 3 is allowed to transfer the cared person 2 to another placement base.

In the example shown in FIG. 2B, the placement base 51 is constituted of two placement portions 51a and 51b linked to each other. The tilt of the placement surface of the placement portion 51a, and the tilt of the placement surface of the placement portion 51b are different from each other. In this embodiment, the tilt angle of the placement portion 51a with respect to the horizontal plane H is θb, and the tilt angle of the placement portion 51b with respect to the horizontal plane H is θc.

In the above arrangement, the carer 3 manipulates the two transfer assist devices 1 to move the supporters 16 toward the placement base 51 (placement portions 51a and 51b), respectively, detect degrees of parallelism between the placement surface of the placement portion 51a and the lower surface of the corresponding supporter 16, and between the placement surface of the placement portion 51b and the lower surface of the corresponding supporter 16, align the lower surfaces of the supporters 16 in parallel to the tilts of the placement surfaces of the placement portions 51a and 51b, respectively, and insert the supporters 16 between the cared person 2 and the placement surface of the placement base 51 (placement portions 51a and 51b). Then, the carer 3 manipulates the two transfer assist devices 1 to lift the cared person 2 by using the supporters 16. Thereby, the carer 3 is allowed to transfer the cared person 2 to another placement base in a state that the cared person 2 lies still.

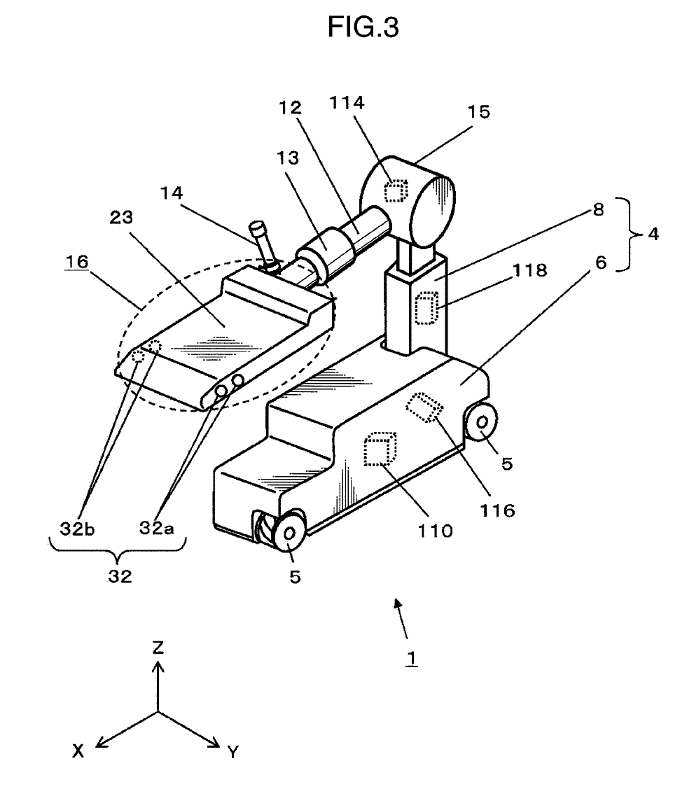

Next, a structure of the transfer assist device 1 is described referring to FIG. 3. FIG. 3 is a perspective view showing a structure of essential parts of the transfer assist device 1 in accordance with the first embodiment of the invention. Referring to FIG. 3, three axes (X-axis, Y-axis, and Z-axis) orthogonal to each other are defined in such a manner that the X-Y plane is a horizontal plane parallel to the ground, and the front side of the transfer assist device 1 faces in X-axis direction. In other words, X-axis direction is aligned with an inserting direction of the supporter 16, and Z-axis is aligned with a vertical direction.

The transfer assist device 1 includes the supporter 16, a joint portion 13, a joint portion 15, an arm portion 12, a support portion 4, a control section 110, and an input section 14.

The supporter 16 is operable to be inserted between the cared person 2 placed on the placement base 51, and the placement surface of the placement base 51 to lift the cared person 2. The supporter 16 includes a belt portion 23 for changing the support position of the cared person 2 to be lifted on the supporter 16, and landing sensors 32 as landing detecting means (or a landing detecting section) for detecting whether the lower surface of the supporter 16 has landed onto the placement surface (or the upper surface) of the placement base 51.

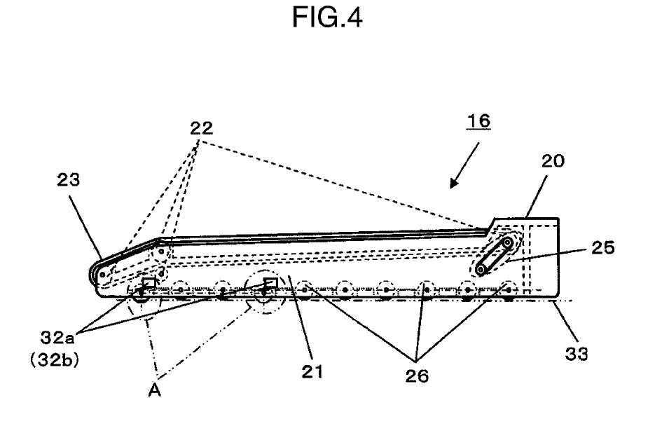

The belt portion 23 is driven to be circulated by a belt driver 25 (see FIG. 4) to be described later. The landing sensors 32 are provided near both ends on a lower surface at a front portion of the supporter 16 in the inserting direction of the supporter 16. The landing sensors 32 near the one end in width direction of the supporter 16 are referred to as landing sensors 32a, and the landing sensors 32 near the other end in width direction of the supporter 16 are referred to as landing sensors 32b. The landing sensors 32a and the landing sensors 32b are away from each other in Y-axis direction. The landing sensors 32a include two sensors away from each other in X-axis direction. Likewise, the landing sensors 32b include two sensors away from each other in X-axis direction. The landing sensors 32a and 32b may be provided at both ends on a lower end of the supporter 6, or at lower ends on side surfaces thereof.

The joint portion 13 is provided as first pivot means (or a first pivot portion) for performing at least one of changing and adjusting the posture of the supporter 16. The joint portion 13 pivotally moves about X-axis with respect to the support portion 4. Likewise, the joint portion 15 is provided as second pivot means (or a second pivot portion) for performing at least one of changing and adjusting the posture of the supporter 16. The joint portion 15 pivotally moves about Y-axis with respect to the support portion 4. The joint portion 15 is connected to the support portion 4, and is also connected to the joint portion 13. The pivot axis of the joint portion 13 perpendicularly intersects with the pivot axis of the joint portion 15. A known bearing mechanism which is rotatable in one axis direction may be used in each of the joint portions 13 and 15. The joint portions 13 and 15 are driven by a joint driver 114 incorporated with e.g. a motor as an electric power source.

The arm portion 12 is operable to link the joint portion 13 and the joint portion 15. Alternatively, the arm portion 12 may have an expansion/contraction mechanism to change the position of the supporter 16 by an expanding/contracting operation of the arm portion 12.

The support portion 4 includes a holding portion 6 as supporter inserting means (or a supporter inserting portion) for inserting the supporter 16 between the cared person 2 and the placement surface of the placement base 51; and a leg portion 8 as elevating means (or an elevating portion) for moving the supporter 16 up and down. The support portion 4 is operable to support the supporter 16 via the joint portion 13, the joint portion 15, and the arm portion 12.

The holding portion 6 has multiple wheels 5. The wheels 5 are driven by a position driver 116 incorporated with e.g. a motor as an electric power source. The wheels 5 are operable to freely move the transfer assist device 1 in forward, backward, leftward and rightward directions, and are pivotally supported on the holding portion 6 about Z axis. The supporter inserting means may be constituted of the wheels 5 and the arm portion 12, or may be constituted solely of the arm portion 12. In the case where solely the arm portion 12 is used, the position of the supporter 16 is changed by an expanding/contracting operation of the arm portion 12.

The leg portion 8 is operable to link the holding portion 6 and the joint portion 15, and move the supporter 16 up and down by a slide mechanism. The slide mechanism is driven by an elevating driver 118 incorporated with e.g. a motor as an electric power source. Alternatively, other elevating means constituted of multiple linking members may be operable to move the supporter 16 up and down by changing the angle defined by the adjoining linking members.

The control section 110 controls the joint driver 114, the position driver 116, the elevating driver 118, and the belt driver 25.

The input section 14 allows the carer 3 to input designation information for manipulating the transfer assist device 1. The designation information is transmitted to the control section 110, which, in turn, controls the joint driver 114, the position driver 116, the elevating driver 118, and the belt driver 25. The input section 14 may be provided with a known input device such as a joystick, a lever, a push switch, or a touch panel, which allows the carer 3 to input an operation command so as to change the moving direction, the moving speed, and an operation designation of the transfer assist device 1. The carer 3 is allowed to manipulate the transfer assist device 1 by operating the input section 14. The input section 14 may further include a notice section or a display section for assisting an input operation of the carer 3. Arrangement examples of the notice section and the display section are described later.

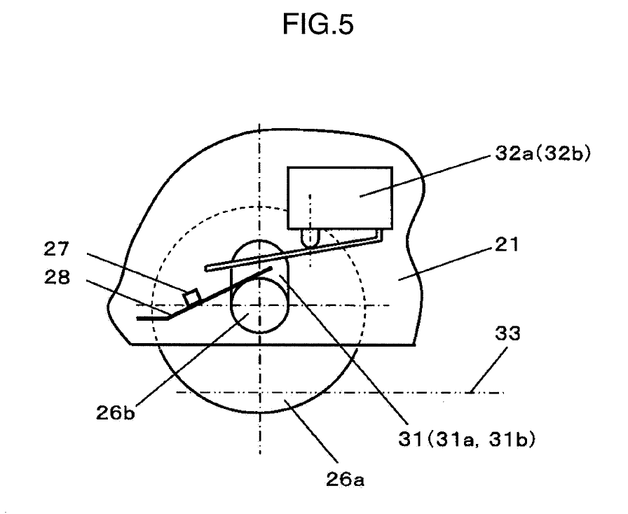

Next, a detailed arrangement of the supporter 16 is described referring to FIGS. 4 and 5. FIG. 4 is a side view showing the structure of the supporter 16 of the transfer assist device 1 in accordance with the first embodiment of the invention. FIG. 5 is a partially enlarged view showing an arrangement of the landing detecting means of the transfer assist device 1 in accordance with the first embodiment of the invention.

As shown in FIG. 4, the supporter 16 includes a frame body 21, belt guide rollers 22, the belt portion 23, the belt driver 25, fixed rollers 26, movable rollers 26a, and the landing sensors 32 (32a and 32b).

The belt portion 23 is held by the belt guide rollers 22 supported on the frame body 21, and driven by the belt driver 25 incorporated with a motor as an electric power source. The belt portion 23 is exposed from the upper surface of a cover member 20, and is movable in a state that the cared person 2 is carried on the belt portion 23. A support plane for supporting the cared person 3, which is constituted of the upper surface of the belt portion 23, has a length substantially equal to the width of the back of a human body in the inserting direction of the supporter 16.

The fixed rollers 26 are fixed at side surfaces of the frame body 21 in a direction orthogonal to the inserting direction of the supporter 16. The fixed rollers 26 are rotatably provided in plural number, with a part thereof being projected from a lower end 33 of the supporter 16. Rotation of the fixed rollers 26 reduces a load to be applied to the supporter 16 when the supporter 16 is inserted between the cared person 2 and the placement surface of the placement base 51.

The landing sensors 32 (32a and 32b) are provided on the frame body 21 in plural number near the front portion of the frame body 21 in the inserting direction of the supporter 16, and near both ends on the lower surface of the frame body 21. Use of the landing sensors 32 (32a and 32b) enables to detect a positional relation between the placement surface of the placement base 51 and the supporter 16 before the supporter 16 is inserted, thereby adjusting the tilt of the supporter 16.

FIG. 5 is a partially enlarged view of the portions “A” (two sites) shown in FIG. 4, specifically showing an arrangement of the landing sensor 32 (32a, 32b) mounted in the portion “A”. As shown in FIG. 5, the movable roller 26a is a roller operable to detect the posture of the supporter 16, and is held in a state that the movable roller 26a is slightly projected downwardly from the lower end 33 of the supporter 16 at the side surfaces of the frame body 21 in a direction orthogonal to the inserting direction of the supporter 16. The movable roller 26a is rotatable about an axis of a roller shaft 26b. The roller shaft 26b is supported in oblong holes 31 in a state that the roller shaft 26b is pressed downwardly by a plate spring 28 at the side surfaces of the frame body 21. The oblong hole 31 formed in one of the side surfaces of the frame body 21 is defined as an oblong hole 31 a, and the oblong hole 31 formed in the other of the side surfaces of the frame body 21 is defined as an oblong hole 31 b. The movable roller 26a is a movable guide member which is movable in a direction normal to the lower surface of the supporter 16. The movable roller 26a is supported in the oblong holes 31 (31a and 31b). The plate spring 28 allows for displacement of the movable roller 26a in a direction perpendicularly intersecting with the lower end of the frame body 21 along the longitudinal direction of the oblong hole 31a, 31b. Thereby, the movable roller 26a is displaced depending on a contact pressure between the supporter 16 and the placement base 51.

The moving direction of the movable roller 26a may have a direction component normal to the lower surface of the supporter 16. Further alternatively, the movable guide member may be a sleigh-like guide member (e.g. a member made of a resin having a small friction coefficient) having a small friction coefficient, or a movable frame, in place of the movable roller 26a. The movable frame is described later. The landing sensor 32 (32a, 32b) is disposed near the roller shaft 26b.

The transfer assist device 1 further includes the control section 110. In the case where the landing sensor 32 (32a, 32b) detects displacement of the corresponding roller shaft 26b, the control section 110 is operable to control a positional relation between the supporter 16 and the placement base 51 such as the tilt of the supporter 16, or the degree of parallelism between the supporter 16 and the placement surface of the placement base 51 so that the output from the landing sensor 32 falls in a predetermined range. In other words, the control section 110 has a function of defining and holding at least one of a parallel state and an adjusted state between the supporter 16 and the placement surface of the placement base 51. The controller 110 determines that the supporter 16 has landed, in the case where the output from the landing sensor 32 falls in the predetermined range.

In the first embodiment, four landing sensors are provided as the landing sensors 32. Alternatively, the number or the arrangement positions of the landing sensors 32 may be optionally defined depending on the structure or the function of the supporter 16, as a design matter. A member for pressing the movable roller 26a may be an elastic member such as a rubber member or a spring, in place of the plate spring 28. A member having an X axis direction component e.g. an oblong hole 31 (31b, 31b) extending in an oblique direction, in place of the oblong hole 31 (31a, 31b) having a Z axis direction component, may obtain substantially the same effect as described above. Further alternatively, the movable rollers 26a may be provided as independent members at the side surfaces of the frame body 21. Further alternatively, the landing sensor 32 may include a lead switch, a proximity switch, or a photoreflector, in place of the microswitch as shown in FIG. 5. Further alternatively, the landing sensor 32 may include a distortion sensor 27, and a conventional method of detecting a distortion of the plate spring 28 that has been deformed by displacement of the movable roller 26a by the distortion sensor 27 may be used to obtain substantially the same effect as described above.

In the embodiment, displacement of the movable roller 26a is detected. Alternatively, a contact pressure may be detected. For instance, a pressure sensor such as a sheet-type pressure sensor for detecting a contact pressure between the supporter 16 and the placement base 51 may be provided at a portion of the supporter 16 for supporting the fixed roller 26 to detect a contact pressure of the placement surface of the placement base 51 with respect to the lower surface of the supporter 16. Thereby, the control section 110 is operable to determine that the supporter 16 has landed, based on an output value from the landing sensor 32, in the case where the contact pressure of the supporter 16 with respect to the placement surface falls in a predetermined pressure range. The predetermined pressure may be substantially equal to the pressure of the placement surface of the placement base 51 to be applied from the cared person 2. Thus, setting the predetermined pressure range substantially equal to the pressure range of the placement surface to be applied from the cared person 2 at the inserted site of the supporter 16 makes a sinking amount of the cared person 2 with respect to the placement surface substantially equal to a sinking amount of the supporter 16 at the inserted site. This enables to suppress generation of a gap resulting from a difference in the sinking amount at the inserted site of the supporter 16, and smoothly inserts the supporter 16 between the placement base 51 and the cared person 2, without a likelihood that a lead end of the supporter 16 may be abutted against the body of the cared person 2.

The predetermined pressure may be a fixed value. For instance, in the case where the body height of the cared person 2 to be loadable on the transfer assist device 1 of the embodiment is from 150 cm to 180 cm, the 50 percentile value of the body weight of a person of 165 cm height i.e. a median of the body heights is about 57 kg. In this case, the pressure value “P” to be applied from the person is 0.035 kgf/cm². Accordingly, the pressure value “P” may be defined as the predetermined pressure, or a range with a margin of about ±10% may be defined as the predetermined pressure range.

The predetermined pressure may be changed depending on a person to be carried on the supporter 16. In the case where the cared person 2 is lifted by the two supporters 16, the distance between the two supporters 16 may be adjusted depending on the body height of the cared person 2. Accordingly, the predetermined pressure may be changed depending on the distance. For instance, the following equation, and data for correlating the body height “L” of the cared person 2 with the distance between the supporters 16 e.g. data corresponding to the distance between the supporters 16 for use in lifting the cared person 2 of 165 cm height, are stored; and the predetermined pressure P(L) is derived by implementing the computation using the following equation, based on the calculated body height “L”. In other words, the pressure value “P” to be applied from the person of 165 cm height is corrected by the actual body height, and the corrected pressure value is used as the predetermined pressure P(L).

Predetermined pressure P(L)=P×L/165

Alternatively, the predetermined pressure range may be a pressure range of the placement surface to be applied from the cared person 2 at the inserted site of the supporter 16. In this modification, the predetermined contact pressure range is a pressure range of the placement surface to be applied from the cared person 2 e.g. the head, the shoulders, the legs, or the back of the cared person 2 at the inserted site of the supporter 16; and is measured in advance by an experiment. A storing section (not shown) of the transfer assist device 1 stores a database representing measurement values at the body sites of the cared person 2. The carer 3 is accessible to the database stored in the storing section by the control section 110. The control section 110 is operable to acquire pressure information from the database, and make the sinking amount of the cared person 2 with respect to the placement surface substantially equal to the sinking amount of the supporter 16 at the inserted site by landing the supporter 16 onto the placement surface based on the pressure information.

The predetermined pressure may be a fixed value or a variable value. In the case where the predetermined pressure is a fixed value, pressure values (e.g. 50-percentile values) at the body sites i.e. the back, the buttocks, and the thighs of a person of e.g. 165 cm height may be stored in the database, and the pressure values may be used as the predetermined pressures. On the other hand, in the case where the predetermined pressure is a variable value, pressure values at the body sites of the person of 165 cm height may be corrected based on the aforementioned data and the actual body height of the cared person 2 by using the data corresponding to the distance between the supporters 16, and the corrected pressure values at the body sites of the cared person 2 may be used as the predetermined pressures.

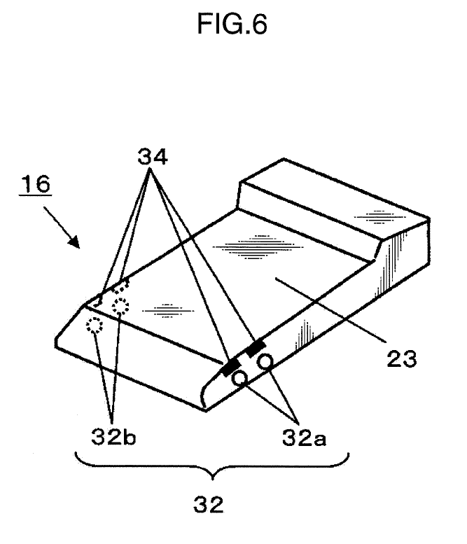

Next, notice means provided in the supporter 16 is described referring to FIG. 6. FIG. 6 is a perspective view showing a structure of the notice means of the transfer assist device 1 in accordance with the first embodiment of the invention.

As shown in FIG. 6, multiple notice sections 34 are provided near the respective landing sensors 32, as notice means for notifying the carer 3 of the statuses of the landing sensors 32. The notice sections 34 are provided at such positions that the carer 3 can directly view, and in a non-contact area with the cared person 2 when the cared person 2 is lifted on the belt portion 23 of the supporter 16. For instance, the notice sections 34 are arranged at the side surfaces of the frame body 21 corresponding to the landing sensors 32.

Examples of the notice section 34 are a light emitting diode, and a liquid crystal panel. The notice section 34 is operable to notify the carer 3 of a landing state of the supporter 16 by utilizing a status change of the notice section 34 such as turning on of light, blinking of light, or turning off of light. Thus, the carer 3 is allowed to easily recognize a state i.e. a tilt of the supporter 16. The notice means is not limited to display means such as a light emitting diode, but may be a sound generating device or a vibrating device to notify the carer 3 through sound or vibration. The sound generating device may generate a message showing a landing state of the supporter 16 such as “THE LEFT SIDE OF THE SUPPORTER HAS LANDED”. The vibrating device may be provided with a “vibration mode” for transmitting different types of vibrations to the hands or a like site of the carer 3, depending on a landing state of the supporter 16, to notify the carer 3 of different messages by setting the “vibration mode” which is different depending on a landing state of the supporter 16 in the similar manner as the sound generating device.

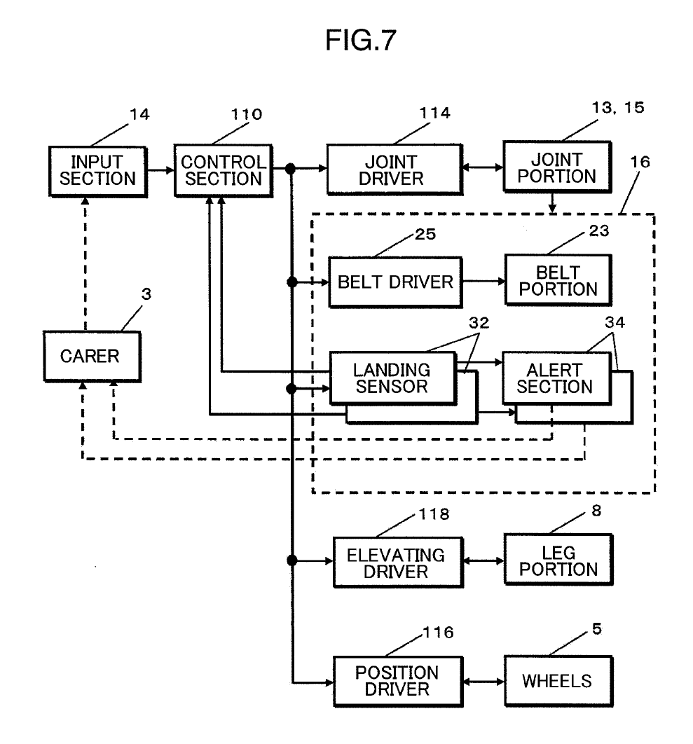

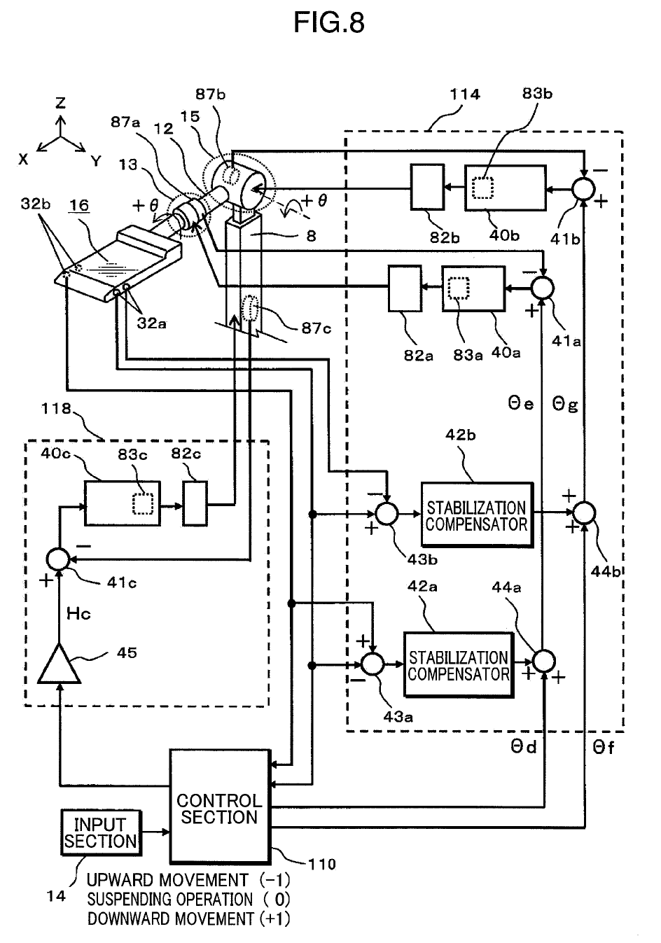

Next, an electrical configuration of the transfer assist device 1, and an operation of a control system of the transfer assist device 1 are described referring to FIGS. 7 and 8.

FIG. 7 is a block diagram showing an electrical configuration of the transfer assist device 1 in accordance with the first embodiment of the invention. FIG. 8 is a diagram for describing a control system of the transfer assist device 1 in accordance with the first embodiment of the invention.

As shown in FIG. 7, the transfer assist device 1 includes the input section 14 for allowing the carer 3 to input an operation command, the joint driver 114 for pivotally moving the joint portions 13 and 15, the belt driver 25 for driving the belt portion 23, the elevating driver 118 for moving the leg portion 8 up and down, the position driver 116 for driving the wheels 5, and the control section 110. The transfer assist device 1 further includes, as input/output means, the landing sensors 32 for detecting a landing state of the supporter 16, and the notice sections 34 for notifying the carer 3 of the landing state of the supporter 16. Driving means each incorporated with e.g. a known motor as an electric power source may be used as the joint driver 114, the belt driver 25, the elevating driver 118, and the position driver 116, respectively.

Next, an operation of a control system of the transfer assist device 1 is described referring to FIG. 8. In this embodiment, the control system is described in detail by an example of the joint driver 114 and the elevating driver 118.

First, the operation of the control system of the joint driver 114 is described. The control system of the joint driver 114 includes a minor control loop and an overall control loop. In the minor control loop, pivotal movements of the joint portion 13 and the joint portion 15 are controlled in response to angle command values issued based on an operation through the input section 14 so as to control the tilt of the supporter 16. In the overall control loop, the angle command values are corrected depending on a disagreement in the degree of parallelism between the supporter 16 and the placement surface of the placement base 51, when the supporter 15 has landed onto the placement base 51 (see FIG. 2).

In the above arrangement, the joint driver 114 is operable to perform angle control by the minor control loop included in the overall control loop. Thereby, even in the case where the operation command from the input section 14 is interrupted, the minor control loop is activated to internally stabilize the operation of the transfer assist device 1. This enables to control the transfer assist device 1, with the tilt of the supporter 16 being retained at a point of time when the operation command is interrupted.

First, the minor control loop for controlling a pivotal movement of the joint portion 13 about X axis by the joint driver 114 is described.

As shown in FIG. 8, the joint driver 114 includes a drive motor 82a for pivotally moving the joint portion 13 about X axis, a rotation angle detector 87a for detecting a rotation angle of the joint portion 13 about X axis, a differential detector 41a for detecting a differential value between the rotation angle of the joint portion 13 detected by the rotation angle detector 87a, and an angle command value θe, and a regulator 40a for driving the drive motor 82a based on the differential value outputted from the differential detector 41 a to control the rotation angle of the joint portion 13.

An example of the drive motor 82a may be a known motor e.g. a DC motor, an AC motor, or a stepping motor.

An example of the rotation angle detector 87a may be a known encoder e.g. a rotation potentiometer or a rotation differential transformer.

The regulator 40a includes a driving circuit 83a for rotating the drive motor 82a in forward or backward direction, based on the differential value outputted from the differential detector 41a.

An example of the driving circuit 83a may be a known driving circuit e.g. a bridge circuit. In this arrangement, the regulator 40a is operable to switch the polarity of the electric power source connected to the drive motor 82a, thereby rotating the drive motor 82a in forward or backward direction. The regulator 40a further includes a differentiator (not shown) to stabilize the control system of the minor control loop. Thereby, the joint driver 114 is operable to stably control the joint portion 13 at a designated rotation angle.

The joint driver 114 further includes a differential detector 43a, a stabilization compensator 42a, and an adder 44a to define the overall control loop for controlling automatic landing adjustment in the case where the lower surface of the supporter 16 has landed onto the placement surface of the placement base 51 (see FIG. 2).

The differential detector 43a is operable to detect a differential value between the outputs from the landing sensor 32a and the landing sensor 32b disposed on the lower surface of the supporter 16.

The stabilization compensator 42a has an integrator (not shown) for accumulatively adding the differential value outputted from the differential detector 43a to stabilize the control system of the overall control loop. Thereby, the joint driver 114 is operable to define one of a parallel state and an adjusted state between the lower surface of the supporter 16 and the placement surface of the placement base 51, based on the differential value detected by the differential detector 43a; and stably hold the state.

The adder 44a is operable to sum up angle information θd and the output from the stabilization compensator 42a to calculate the angle command value 8e.

In this way, the joint driver 114 controls the tilt of the supporter 16 in Y-axis direction (about X axis) depending on an operation command θd from the input section 14; and correct the operation command θd into the angle command value θe depending on a disagreement in the degree of parallelism between the lower surface of the supporter 16 and the placement surface in Y-axis direction in landing the supporter 16 onto the placement base 51 by activating the overall control loop with respect to the operation command value θd, in the case where the lower surface of the supporter 16 has landed onto the placement surface of the placement base 51. Thereby, the joint driver 114 is operable to define one of a parallel state and an adjusted state between the supporter 16 and the placement surface of the placement base 51, depending on the tilt of the supporter 16 in Y-axis direction; and hold the state.

Next, the minor control loop for controlling a pivotal movement of the joint portion 15 about Y axis by the joint driver 114 is described.

As shown in FIG. 8, the joint driver 114 includes a drive motor 82b for pivotally moving the joint portion 15 about Y axis, a rotation angle detector 87b for detecting a rotation angle of the joint portion 15 about Y axis, a differential detector 41 b for detecting a differential value between the rotation angle of the joint portion 15 detected by the rotation angle detector 87b, and an angle command value θg, and a regulator 40b for driving the drive motor 82b based on the differential value outputted from the differential detector 41b to control the rotation angle of the joint portion 15.

An example of the drive motor 82b may be a known motor e.g. a DC motor, an AC motor, or a stepping motor.

An example of the rotation angle detector 87b may be a known encoder e.g. a rotation potentiometer or a rotation differential transformer.

The regulator 40b has a driving circuit 83b for rotating the drive motor 82b in forward or backward direction, based on the differential value outputted from the differential detector 41b.

An example of the driving circuit 83b may be a known driving circuit e.g. a bridge circuit. In this arrangement, the regulator 40b is operable to switch the polarity of the electric power source connected to the drive motor 82b, thereby rotating the drive motor 82b in forward or backward direction. Further, the regulator 40b has a differentiator (not shown) to stabilize the control system of the minor control loop. Thereby, the joint driver 114 is operable to stably control the joint portion 15 at a designated rotation angle.

The joint driver 114 further includes a differential detector 43b, a stabilization compensator 42b, and an adder 44b to define the overall control loop for controlling automatic landing adjustment in the case where the lower surface of the supporter 16 has landed onto the placement surface of the placement base 51 (see FIG. 2).

The differential detector 43b is operable to detect a differential value between the outputs from the two landing sensors 32a provided e.g. on the lower surface of the supporter 16 at positions away from each other in X-axis direction.

The stabilization compensator 42b has an integrator (not shown) for accumulatively adding the differential value outputted from the differential detector 43b to stabilize the control system of the overall control loop. Thereby, the joint driver 114 is operable to define one of a parallel state and an adjusted state between the lower surface of the supporter 16 and the placement surface of the placement base 51 (see FIG. 2), based on the differential value detected by the differential detector 43b; and stably hold the state.

The adder 44b is operable to sum up angle information θf and the output from the stabilization compensator 42b to calculate the angle command value θg.

In this way, the joint driver 114 controls the tilt of the supporter 16 in X-axis direction (about Y axis) depending on the operation command value θg from the input section 14; and correct the operation command value θg into the angle command value θg depending on a disagreement in the degree of parallelism between the supporter 16 and the placement surface in X-axis direction in landing the supporter 16 onto the placement base 51 by activating the overall control loop with respect to the operation command value θg, in the case where the lower surface of the supporter 16 has landed onto the placement surface of the placement base 51 (see FIG. 2). Thereby, the joint driver 114 is operable to define one of a parallel state and an adjusted state between the supporter 16 and the placement surface of the placement base 51, depending on the tilt of the supporter 16 in X-axis direction; and hold the state.

As described above, the joint driver 114 is operable to perform angle control by the minor control loop included in the overall control loop. Thereby, even in the case where the operation command from the input section 14 is interrupted, the minor control loop is activated to internally stabilize the operation of the transfer assist device 1. This enables to control the transfer assist device 1, with the tilt of the supporter 16 being retained at a point of time when the operation command is interrupted. Thereby, an erroneous operation of e.g. sandwiching the cared person 2 between the two supporters 16 is avoided, thereby enhancing safe use of the transfer assist device 1.

Next, an operation of the control system of the elevating driver 118 for moving the supporter 16 up and down is described.

As shown in FIG. 8, the elevating driver 118 is operable to move the leg portion 8 up and down in Z-axis direction, depending on a height position command value He issued from the input section 14 to control a vertical movement of the supporter 16. The elevating driver 118 includes a drive motor 82c for moving the leg portion 8 up and down in Z-axis direction, a height position detector 87c for detecting a suspended position of the supporter 16 in height direction in moving the leg portion 8 up and down, a differential detector 41c for detecting a differential value between the suspended position of the supporter 16 in height direction which has been detected by the height position detector 87c, and the height position command value Hc, and a regulator 40c for driving the drive motor 82c based on the differential value outputted from the differential detector 41c to control the suspended position of the supporter 16 in height direction.

An example of the drive motor 82c may be a known motor e.g. a DC motor, an AC motor, or a stepping motor.

An example of the height position detector 87c may be a known rectilinear detector or a known rotation position detector e.g. an optical encoder, a magnetic encoder, a potentiometer, or a differential transformer.

The regulator 40c includes a driving circuit 83c for rotating the drive motor 82c in forward or backward direction, based on the differential value outputted from the differential detector 41c, to move the leg portion 8 up and down in Z-axis direction. An example of the driving circuit 83c may be a known driving circuit e.g. a bridge circuit. The regulator 40c is operable to switch the polarity of the electric power source to be connected to the drive motor 82c, thereby rotating the drive motor 82c in forward or backward direction.

The regulator 40a further includes a differentiator (not shown) to stabilize the control system of the minor control loop. This enables to move the leg portion 8 up and down, thereby positioning the supporter 16 at a designated height position.

The elevating driver 118 further includes a height position generator 45 for generating the height position command value He of the supporter 16.

The height position generator 45 is operable to accumulatively add e.g. a direction command value outputted from the control section 110 to output a height position command value. In response to input of a value “−1” indicating an upward movement, as an operation command from the input section 14, the control section 110 is operable to output a direction command value “−1” indicating an upward movement to the height position generator 45. Likewise, in response to input of a value “0” indicating a suspending operation, as an operation command from the input section 14, the control section 110 is operable to output a direction command value “0” indicating a suspending operation to the height position generator 45. Likewise, in response to input of a value “+1” indicating a downward movement, as an operation command from the input section 14, the control section 110 is operable to output a direction command value “+1” indicating a downward movement to the height position generator 45.

The height position generator 45 is operable to accumulatively add the direction command value by multiplying a predetermined coefficient. For instance, in the case where the predetermined coefficient is “2”, the height position generator 45 accumulatively adds the direction command value by multiplying the direction command value two times. The positioning speed for use in adjusting the height of the supporter 16 is variable by changing the predetermined coefficient. An increased coefficient increases the positioning speed, and a decreased coefficient reduces the positioning speed. The predetermined coefficient is not limited to “2”.

The value “+1” indicating a downward movement is inputted to the control section 110 as an operation command from the input section 14. In the case where the lower surface of the supporter 16 has landed onto the placement surface of the placement base (see FIG. 2), and both of the outputs from the landing sensors 32a and 32b indicate “ON” states, the control section 110 outputs a direction command value “0” indicating a suspending operation to the height position generator 45.

As described above, the elevating driver 118 is operable to control the suspended position of the supporter 16 in height direction in response to an operation command from the input section 14. In the case where the lower surface of the supporter 16 has landed onto the placement surface of the placement base (see FIG. 2), the elevating driver 118 suspends the vertical movement of the supporter 16, and retains the supporter 16 at the height position.

In the transfer assist device 1 having the above arrangement, the control section 110 is operable to activate one of the joint portion 13, the joint portion 15, and the leg portion 8 so that the outputs from the landing sensors 32 fall in the predetermined range; define one of a parallel state and an adjusted state between the placement surface of the placement base 51 (see FIG. 2) and the supporter 16; and hold the state. Thus, the transfer assist device 1 automatically adjusts the spatial posture such as the position and the angle of the supporter 16 depending on the tilt of the placement surface of the placement base 51 on which the cared person 2 is placed. This allows the carer 3 to smoothly lift and transfer the cared person 2 from the placement base 51, without especially paying attention to a positional relation between the placement surface and the supporter 16.

The transfer assist device 1 is provided with the landing sensors 32a and 32b on the lower surface of the supporter 16 at positions away from each other in a direction orthogonal to the pivot axis of the joint portion 13. The landing sensors 32a and 32b are each constituted of two sensors provided at the lower surface of the supporter 16 at positions away from each other in a direction orthogonal to the pivot axis of the joint portion 15. In lowering the supporter 16 from above the placement surface toward the placement surface by a sliding operation of the leg portion 8, in the case where one of the landing sensors 32 has detected landing of the supporter 16 onto the placement surface, the transfer assist device 1 is operable to pivotally move one of the joint portion 13 and the joint portion 15 in association with the sliding operation of the leg portion 8 to retain the height position of the landing sensor 32 that has detected the landing with respect to the placement surface. In the case where two or more of the landing sensors 32 have detected the landing, a pivotal movement of the joint portion 13, 15 about the axis corresponding to a tilt of the supporter 16 is terminated. Then, at a point of time when all the pivotal movements of the joint portions 13 and 15 are terminated, the transfer assist device is operable to suspend the lowering operation of the supporter 16 by the sliding operation of the leg portion 8. Thereby, the transfer assist device 1 is operable to land the supporter 16 in parallel to the placement surface, and hold the supported 16 in suspended position.

In driving the wheels 5 and inserting the supporter 16 between the cared person 2 and the placement surface, the transfer assist device 1 is operable to lower the supporter 16 by a sliding operation of the leg portion 8, in the case where none of the landing sensors 32 has detected the landing. In the case where the output from one of the landing sensors 32 provided in the direction orthogonal to the pivot axis of the joint portion 13, 15 is larger than the predetermined range, the transfer assist device 1 is operable to pivotally move the joint portion 13, 15 in such a direction that the landing sensor whose output is larger than the predetermined range is moved away from the placement surface. On the other hand, in the case where the output from one of the landing sensors 32 is smaller than the predetermined range, the transfer assist device 1 is operable to pivotally move the joint portion 13, 15 in such a direction that the landing sensor whose output is smaller than the predetermined range is moved toward the placement surface. Thus, output statuses of the landing sensors 32 are kept in a predetermined range. This enables to secure a predetermined contact state of the supporter 16 with respect to the placement surface during an inserting operation of the supporter 16.

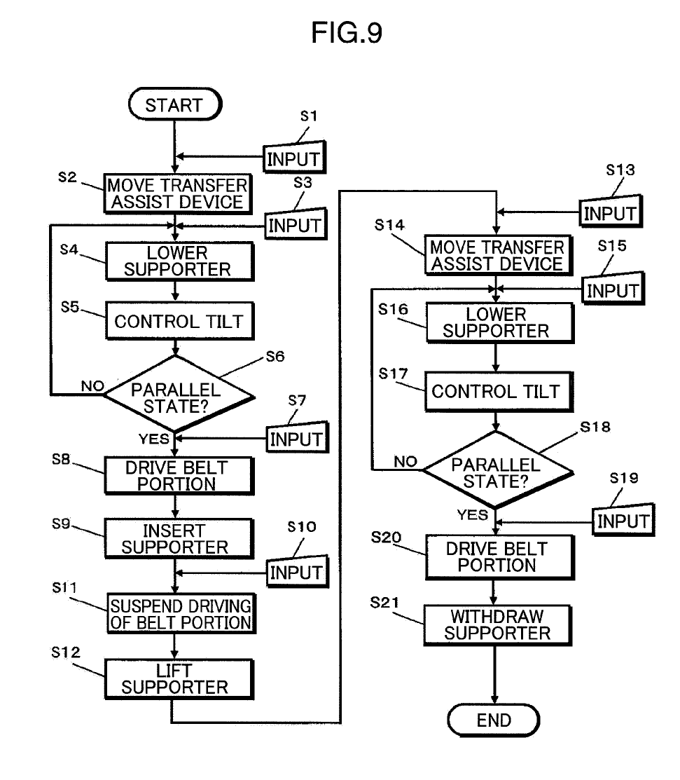

Next, an operation of the transfer assist device 1 is described referring to FIG. 9. FIG. 9 is a flowchart showing an operation to be performed by the transfer assist device 1 in accordance with the first embodiment of the invention. In the following, there are described an operation procedure of the carer 3 and an operation of the transfer assist device 1, in the case where the transfer assist device 1 is operated to lift and transfer the cared person 2 placed on the placement base 51.

As shown in FIG. 9, the carer 3 inputs an operation command to the input section 14 so as to move the transfer assist device 1 toward a side of the placement base 51 on which the cared person 2 is placed (Step S1). Then, in response to the operation command, the control section 110 controls the position driver 116 to drive the wheels 5 so as to move the transfer assist device 1 toward the side of the placement base 51 (Step S2).

Then, the carer 3 inputs designation information to lower the supporter 16, and insert the supporter 16 between the cared person 2 and the placement base 51 in a parallel state between the placement surface of the placement base 51 and the lead end of the supporter 16 (Step S3).

In response to the input, the control section 110 transmits control information to the joint driver 114 and the elevating driver 118 to move the joint portions 13, 15, and the leg portion 8. The control section 110 may control the position driver 116 to drive the wheels 5 so as to adjust the position of the transfer assist device 1, as required.

Then, in lowering the supporter 16 from above the placement surface toward the placement surface by a sliding operation of the leg portion 8, in the case where one of the landing sensors 32 has detected the landing of the supporter 16 onto the placement surface, the control section 110 pivotally moves one of the joint portion 13 and the joint portion 15 to retain the height of the landing sensor 32 that has detected the landing with respect to the placement surface; in the case where two or more of the landing sensors 32 have detected the landing in one of X direction and Y direction, the control section 110 terminates a pivotal movement of the joint portion 13, 15 about the axis corresponding to the tilt of the supporter 16 in the direction; and at a point of time when all the pivotal movements of the joint portions 13 and 15 in the other direction are terminated, the control section 110 suspends the lowering operation of the supporter 16 by the sliding operation of the leg portion 8 (Steps S4, S5, and S6). Thereby, the transfer assist device 1 is operable to land the supporter 16 in parallel to the placement surface, and hold the supporter 16 in suspended position.

After the lowering operation of the supporter 16 is suspended, the carer 3 checks on/off states of the light emitting diodes of the notice sections 34. For instance, in the case where the carer 3 confirms that at least three of the landing sensors 32 have detected the landing by on/off states of the notice sections 34, the carer 3 inputs a designation to the input section 14 so as to insert the supporter 16 between the cared person 2 and the placement base 51 in a state that the lower end 33 of the supporter 16 is contacted with the upper surface of the placement base 51 (Step S7). Thus, the carer 3 is allowed to insert the supporter 16 between the cared person 2 and the placement base 51, with the tilt of the lower end 33 of the supporter 16 being retained, without especially paying attention to the tilt of the supporter 16 in inserting the supporter 16.

Then, in inserting the supporter 16, the control section 110 issues a command to the belt driver 25 to circulate the belt portion 23 exposed from the upper portion of the supporter 16 in a direction opposite to the moving direction of the supporter 16 at a speed substantially equal to the moving speed of the supporter 16 (Step S8). Then, the control section 110 issues a command to the position driver 116 to drive the wheels 5 so as to move the transfer assist device 1 in forward direction (X axis direction) in association with the circulation of the belt portion 23, and insert the supporter 16 (Step S9). By performing the above operation, in inserting the supporter 16, the relative speed between the cared person 2 and the belt portion 23 becomes substantially “0”. Thereby, the supporter 16 can be smoothly inserted by the fixed rollers 26 provided on the lower end 33 of the supporter 16, without a likelihood that the back of the cared person 2 may be frictionally contacted with the belt portion 23 of the supporter 16.

Then, the carer 3 inputs designation information to the input section 14 so as to lift the cared person 2 on the lifting surface of the supporter 16, when it is judged that the supporter 16 has been sufficiently inserted between the cared person 2 and the upper surface of the placement base 51 (Step S10). In response to the input, the control section 110 suspends the driving of the belt driver 25 of the supporter 16 so as to suspend the circulation of the belt portion 23 (Step S 11). Simultaneously or immediately after the driving operation of the belt portion 23 is suspended, the control section 110 issues a command to the elevating driver 118 to drive the leg portion 8 so as to move the supporter 16 in upward direction (Step S 12).

Then, the carer 3 inputs designation information to the input section 14 so as to move the transfer assist device 1 to another placement base 51 as a transfer destination (Step S13). In response to the input, the control section 110 controls the position driver 116 to move the transfer assist device 1 to the transfer destination e.g. the another placement base 51 (Step S 14).

After confirming that the transfer assist device 1 has sufficiently approached the placement base 51 as the transfer destination, the carer 3 inputs designation information to the input section 14 so as to contact the supporter 16 with the placement surface of the placement base 51 as the transfer destination (Step S15).

Then, in response to the input, the control section 110 controls the elevating driver 118 or the joint driver 114 to perform a vertical movement of the leg portion 8 or a pivotal movement of the joint portion 13, 15, whereby the supporter 16 carrying the cared person 2 is contacted with the placement surface of the placement base 51 as the transfer destination.

Then, in lowering the supporter 16 from above the placement surface toward the placement surface by a sliding operation of the leg portion 8, in the case where one of the landing sensors 32 has detected the landing of the supporter 16 onto the placement surface, the control section 110 pivotally moves one of the joint portion 13 and the joint portion 15 to retain the height of the landing sensor 32 that has detected the landing with respect to the placement surface; in the case where two or more of the landing sensors 32 have detected the landing in one of X direction and Y direction, the control section 110 terminates a pivotal movement of the joint portion 13, 15 about the axis corresponding to the tilt of the supporter 16 in the direction; and at a point of time when all the pivotal movements of the joint portions 13 and 15 in the other direction are terminated, the control section 110 suspends the lowering operation of the supporter 16 by the sliding operation of the leg portion 8 (Steps S16, S17, and S18).

Then, after the lowering operation of the supporter 16 is suspended, the carer 3 checks on/off states of the notice sections 34. For instance, in the case where the carer 3 confirms that at least three of the landing sensors 32 have detected the landing (at least one of a parallel state and an adjusted state between the lower end 33 of the supporter 16 and the placement surface of the placement base 51), the carer 3 inputs a designation to the input section 14 so as to move the supporter 16 in backward direction (a direction opposite to X direction) (Step S 19). Then, in response to the input, the control section 110 issues a command to the belt driver 25 to circulate the belt portion 23 in a direction opposite to the moving direction of the supporter 16 and at a speed substantially equal to the moving speed of the supporter 16 (Step S20). Simultaneously or immediately after the driving operation of the belt portion 23, the control section 110 controls the position driver 116 to drive the wheels 5 so as to move the transfer assist device 1 in backward direction, whereby the supporter 16 is withdrawn from a space between the cared person 2 and the placement base 51 (Step S21). Similarly to the inserting operation, in withdrawing the supporter 16, the supporter 16 is smoothly withdrawn by the function and the operation of the belt portion 23 and the fixed rollers 26, without a likelihood that the supporter 16 may be frictionally contacted with the body of the cared person 2.

As described above, with use of the transfer assist device 1 in accordance with the first embodiment of the invention, even in a condition that the placement surface is not horizontal in inserting the supporter 16 between the cared person 2 and the placement surface of the placement base 51, at least one of the pivotal movements of the joint portions 13 and 15, and the vertical movement of the leg portion 8 is performed in inserting the supporter 16 between the cared person 2 and the placement surface; and at least one of a parallel state and an adjusted state between the placement surface and the supporter 16 is defined and held by setting the outputs from the landing sensors 32 to a value in the predetermined range. Thus, the transfer assist device 1 is operable to automatically adjust the spatial posture such as the position and the angle of the supporter 16 with respect to the tilt of the placement surface in transferring the cared person 2. This allows the carer 3 to smoothly lift and transfer the cared person 2 from the placement base 51, without especially paying attention to a positional relation between the placement surface and the supporter 16.

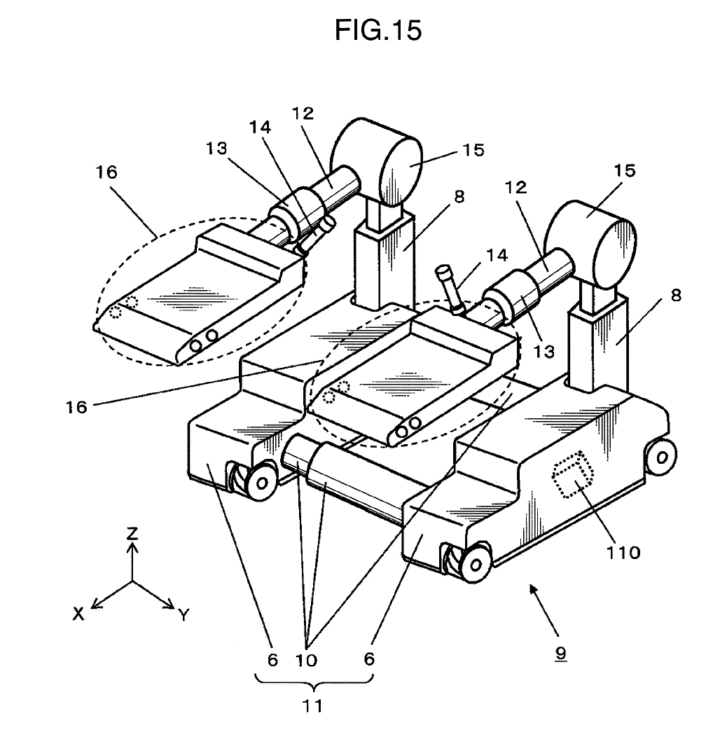

In the case where a control device (not shown) for controlling two transfer assist device 1 in cooperation with each other, and one of the transfer assist devices 1 is manipulated, the other of the transfer assist devices 1 may be operated in cooperation with the one of the transfer assist devices 1. For instance, in the case where the carer 3 manipulates the one transfer assist device 1 to move the one transfer assist device 1 in forward, backward, leftward, and rightward directions, the control device may control the two transfer assist devices 1 in forward, backward, leftward, and rightward directions, while keeping the distance between the supporters 16 mounted on the respective transfer assist devices 1 at a constant value. In the modification, the control device may have substantially the same arrangement as a control section 110 in the third embodiment and shown in FIG. 15.

In the above arrangement, tilts of the supporters 16 may be individually adjusted with respect to a placement base 51 having placement surfaces with tilts different from each other, such as a reclining bed, by using multiple transfer assist devices 1. Thus, the multiple transfer assist devices are compatible with a variety of kinds of placement bases. For instance, the transfer assist devices may be compatible with a complicated-shaped placement base 51 having placement surfaces with tilts of two or more. Thus, the embodiment provides a transfer assist device with a multi-supporter mechanism.

A control section 110 provided in one of two transfer assist devices 1 may be used as the control device of the transfer assist device with a multi-supporter mechanism. The number of transfer assist devices 1 to be linked is not limited to two. Three or more transfer assist devices 1 may be linked, depending on the shape of the placement surface of the placement base 51.

The arrangement position of the landing sensors 32a and 32b of the transfer assist device 1 is not limited to the arrangement position in the embodiment. In the following, modifications of the arrangement position of the landing detecting means of the transfer assist device 1 are described.

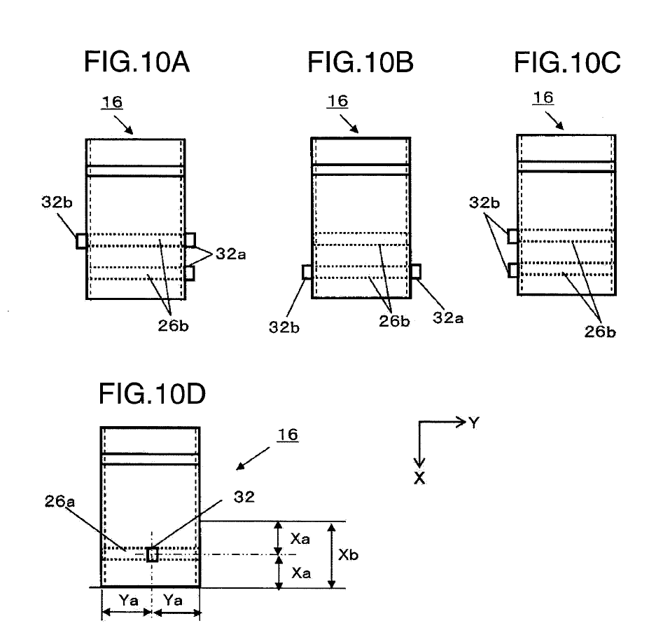

FIGS. 10A through 10D are plan views showing examples of the arrangement position of the landing detecting means of the supporter 16 of the transfer assist device 1 in accordance with the first embodiment of the invention. FIGS. 10A and 10D show examples of the arrangement position in the case where the tilts of the lower end surface 33 of the supporter 16 in X axis direction and Y axis direction are detected, respectively. FIG. 10B shows an example of the arrangement position in the case where the tilt of the lower end 33 of the supporter 16 in Y axis direction is detected. FIG. 10C shows an example of the arrangement position in the case where the tilt of the lower end surface 33 of the supporter 16 in X axis direction is detected.

Specifically, referring to FIG. 10A, landing sensors 32a are arranged at one ends of roller shafts 26b of two movable rollers 26a, and a landing sensor 32b is arranged at the other end of one of the roller shafts 26b. With the above arrangement, a transfer assist device 1 provided with a joint portion 13 operable to pivotally move about X axis in the inserting direction of the supporter 16, and a joint portion 15 operable to pivotally move about Y axis in a direction orthogonal to the inserting direction on the lower surface of the supporter 16 is operable to detect the tilt of the lower end surface 33 of the supporter 16 both in the inserting direction of the supporter 16 and the direction orthogonal to the inserting direction. This enables to adjust the degree of parallelism between the supporter 16 and the upper surface of the placement base 51.

FIG. 10B shows an example, wherein a landing sensor 32a and a landing sensor 32b are arranged at both ends of a roller shaft 26b of one of movable rollers 26a, respectively. With this arrangement, the landing sensor 32a, 32b is operable to detect an displacement of the roller shaft 26b. The transfer assist device 1 is operable to detect the tilt of the lower end 33 of the supporter 16 by using a joint portion 13 operable to pivotally move about X axis in the inserting direction of the supporter 16; and adjust the degree of parallelism between the lower end 33 of the supporter 16 and the upper surface of a placement base 51. This is advantageous in providing an effect of the embodiment, for instance, in the case where the placement base 51 such as a bed is not tilted with respect to the inserting direction of the supporter 16. In the case where there is no need of adjusting the tilt of the placement base 51 in X axis direction, and a pivotal movement about Y axis is not required, for instance, in the case of a bed, the joint portion 15 may be omitted.

FIG. 10C shows an example, wherein two landing sensors 32b are arranged near roller shafts 26b of two movable rollers 26a, respectively, at one of side surfaces of the supporter 16. This arrangement enables to detect the tilt of the supporter 16 in X axis direction, thereby aligning the lower end surface 33 of the supporter 16 in parallel to the upper surface of a placement base 51.

FIG. 10D shows an example, wherein a single landing sensor 32 is arranged near a center on the lower surface of the supporter 16 in width direction of the supporter 16 i.e. a direction orthogonal to the inserting direction of the supporter 16, for instance, at a position away from the distance Ya from side surfaces of the supporter 16. In this arrangement, the landing sensor 32 is actuated when both ends of a roller shaft 26b of a movable roller 26a are moved upwardly in oblong holes 31, respectively. This also enables to detect whether the lower end surface 33 of the supporter 16 is aligned in parallel to the placement surface of a placement base 51 in Y axis direction. In this example, the movable roller 26a is disposed at a position away from a lead end of the lower end surface 33 of the supporter 16 by the distance Xa, in other words, at a center position in an area covering the distance Xb from a lead end of the supporter 16. Specifically, the landing sensor 32 is disposed at a centroid position in the area covering the distance Xb from the lead end of the supporter 16. In this arrangement, in the case where the lead end of the lower end surface 33 of the supporter 16 is contacted with the placement base 51 in the area covering the distance Xb in X axis direction, the lead end surface 33 of the supporter 16 is aligned in parallel to the placement surface of the placement base 51 in X axis direction. In the arrangement shown in FIG. 10D, in the case where the supporter 16 is not aligned in parallel to the placement base 51, it is difficult to judge in which direction the supporter 16 is to be tilted. In view of this, the landing sensor 32 is provided to check the degree of parallelism. The landing sensor 32 may be combined with the landing sensors 32a and 32b shown in FIGS. 10A through 10C. The distance Xb for use in contacting the lead end of the lower end 33 of the supporter 16 with the placement base 51 is set to a proper value in advance in inserting the supporter 16.

### Second Embodiment

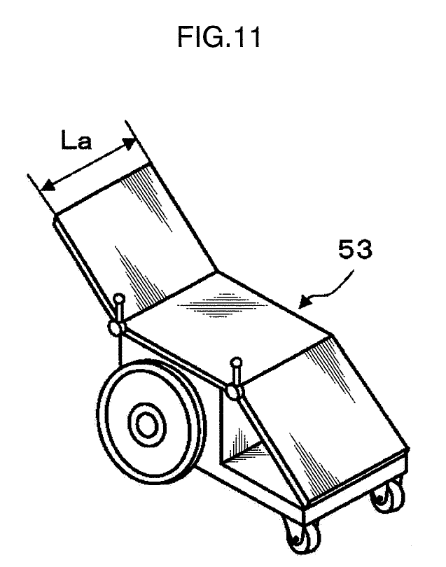

In this section, a supporter 17 in accordance with the second embodiment of the invention is described referring to FIGS. 11 through 14B.

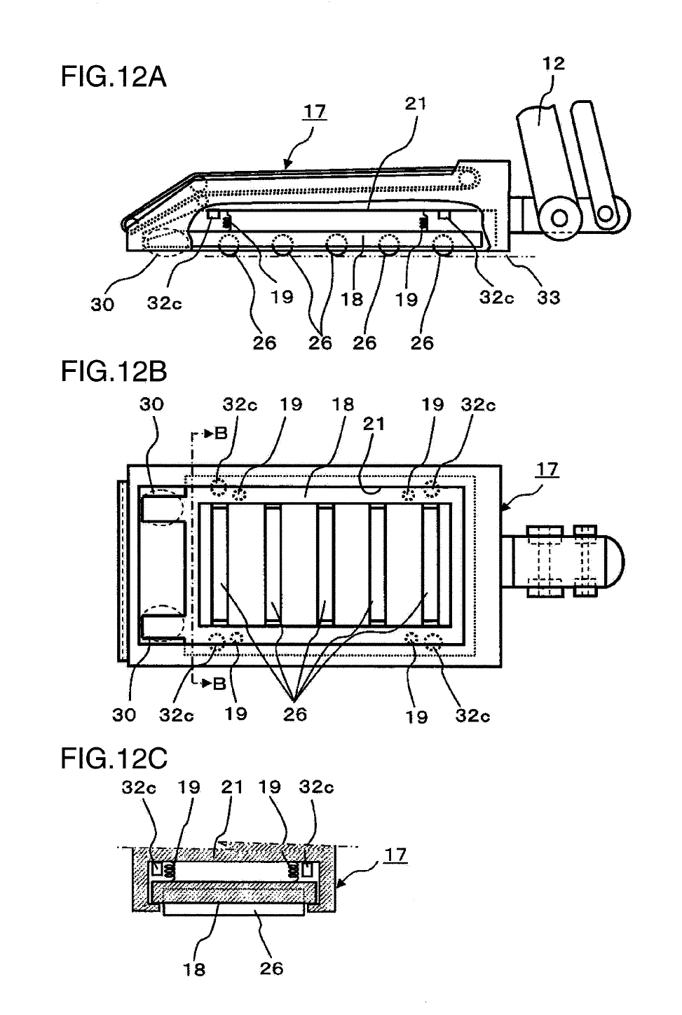

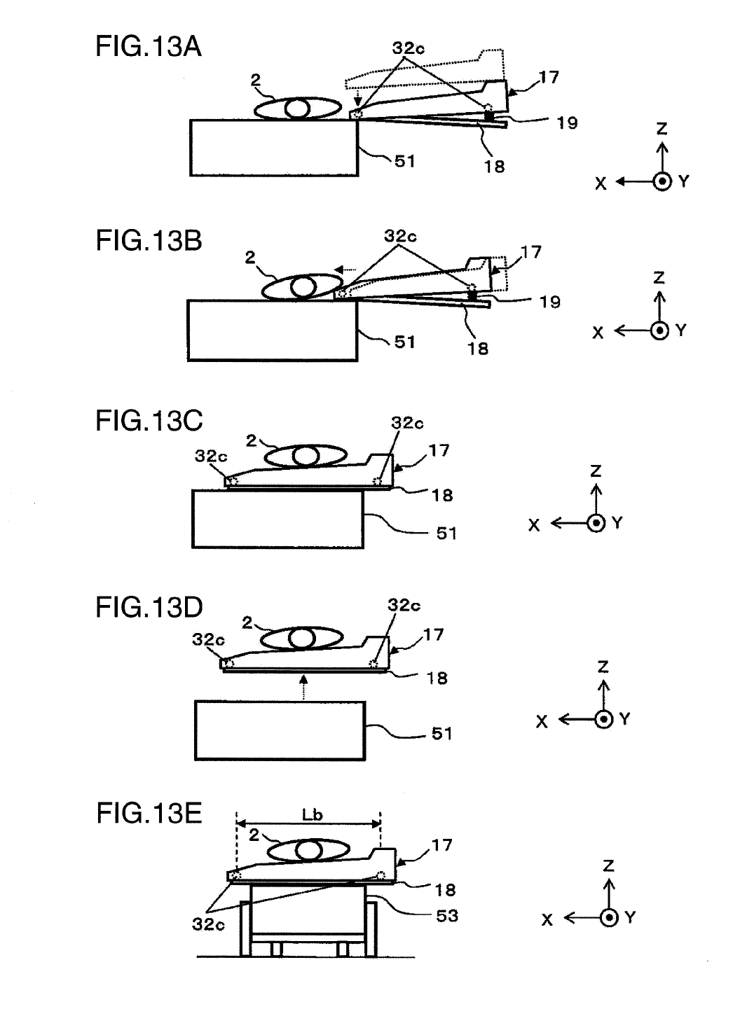

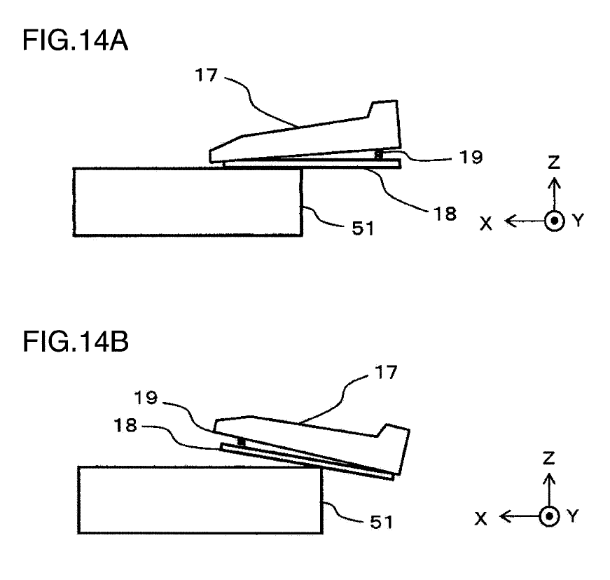

FIG. 11 is a diagram showing an example of a wheelchair for use with a transfer assist device 1 in accordance with the second embodiment of the invention. FIG. 12 is a diagram showing a structure example of the supporter 17 in accordance with the second embodiment of the invention. FIGS. 13A through 13E are diagrams for describing an operation of using the supporter 17 of the transfer assist device 1 in accordance with the second embodiment of the invention. FIGS. 14A and 14B are diagrams showing examples of using the supporter 17 of the transfer assist device 1 in accordance with the second embodiment of the invention. Elements in the second embodiment having the same functions as those in the transfer assist device 1 in accordance with the first embodiment are indicated with the same reference numerals, and description thereof is omitted herein.

In the first embodiment, one of a parallel state and an adjusted state between the placement surface and the supporter 16 is defined and held by detecting displacement of the movable roller 26a (or the roller shaft 26b) provided on the lower surface of the supporter 16 of the transfer assist device 1. In other words, the first embodiment is made based on the premise that the supporter 16 lands onto the placement base 51 (see FIG. 2) having a relatively large width such as a bed.

In the second embodiment, there is described the supporter 17 capable of defining and holding one of a parallel state and an adjusted state between the placement surface and the supporter 17, in landing the supporter 17 onto a placement base 51 having a relatively small width as compared with a bed (see FIG. 2) e.g. a wheelchair 53 as shown in FIG. 11. In the transfer assist device 1 in accordance with the second embodiment, the supporter 17 is used, in place of the supporter 16.

In the following, details on the supporter 17 are described. FIG. 12A is a side view of the supporter 17. FIG. 12A shows the supporter 17, with a part thereof being cut away. As shown in FIG. 12A, the supporter 17 includes a frame body 21 fixed to the main body of the supporter 17 at a lower surface of the supporter 17, a movable frame 18 supported on the frame body 21, and landing sensors 32c for detecting displacement of the movable frame 18 in normal direction to the lower surface of the supporter 17. The moving direction of the movable frame 18 may have a normal direction component to the lower surface of the supporter 17.

The supporter 17 has springs 19 as resilient members between the frame body 21 and the movable frame 18. The springs 19 are operable to urge the movable frame 18 toward the lower surface of the supporter 17 in normal direction to the lower surface of the supporter 17. The movable frame 18 is disposed at an inner spece of the frame body 21, and is displaced in vertical direction depending on expansion/contraction of the springs 19.

FIG. 12B is a plan view showing the lower surface of the supporter 17. The frame body 21 has an opening corresponding to a majority area of the lower surface of the supporter 17. The movable frame 18 has dimensions substantially equal to the majority area of the opening of the frame body 21. As shown in FIG. 12B, the movable frame 18 holds fixed rollers 26 extending in a direction orthogonal to the inserting direction of the supporter 17. As shown in FIG. 12A, the movable frame 18 rotatably supports an array of the fixed rollers 26 in a state that each of the fixed rollers 26 is slightly projected downwardly from a lower end surface 33 of the supporter 17. Rotation of the fixed rollers 26 reduces a load in inserting the supporter 17 between the cared person 2 and the placement surface of the placement base 51.

FIG. 12C is a sectional view taken along the line B-B in FIG. 12B, showing primary parts of the supporter 17. As shown in FIG. 12C, the movable frame 18 is supported on the frame body 21 at the lower surface of the supporter 17, and is displaceably supported in normal direction to the lower surface of the supporter 17. Thereby, a part of the movable frame 18 e.g. the fixed rollers 26 or the lower surface of the movable frame 18 (a partial area which makes point, linear, or planar contact with the placement surface at a front portion, an intermediate portion, or a rear portion of the movable frame 18) is contactable with the placement surface 51 of the wheelchair 53, at the lower surface of the supporter 17.

The embodiment is not limited to the structure as shown in FIGS. 12A through 12C. For instance, the movable frame 18 may be displaceably supported on the lower surface of the supporter 17 at a position away from the frame body 21 by a certain distance, by using a connecting member such as a wire. Further alternatively, a spring may be used, in place of the wire. Further alternatively, a guide member, a slide mechanism, or a like member may be provided on the lower surface of the supporter 17 to rectilinearly support the movable frame 18. As far as a mechanism capable of displacing the movable frame 18 in normal direction to the lower surface of the supporter 17 is used, the movable frame 18 is contactable with one of the landing sensors 32c by displacement of the movable frame 18, thereby actuating the landing sensor 32c.

The springs 19 are disposed near four corners of the movable frame 18. For instance, a known compression coil spring, plate spring, or disc spring may be used as the springs 19. The springs 19 are operable to urge the movable frame 18 toward the lower surface of the supporter 17 in normal direction to the lower surface of the supporter 17. This enables to suppress displacement of the movable frame 18 toward the frame body 21 due to tilt or vibration of the supporter 17, or an external force to be applied to the supporter 17, thereby preventing erroneous detection by the landing sensors 32c. The number of the springs 19 is not limited to four.

The landing sensors 32c are arranged away from each other between the frame body 21 and the movable frame 18. Each of the landing sensors 32c is fixed to the frame body 21. Thereby, in response to contact of one of the landing sensors 32c with the movable frame 18 resulting from displacement of the movable frame 18, the landing sensor 32c is actuated by a contact pressure against the movable frame 18. The landing sensors 32c may be identical to the landing sensors 32a. In the arrangement example shown in FIG. 12B, four landing sensors 32c are disposed near four corners of the movable frame 18, respectively. Specifically, the landing sensors 32c are arranged in X axis direction and Y axis direction. Mounting the landing sensors 32c on the frame body 21 serving as the main body of the supporter 17 facilitates a wiring operation with respect to the landing sensors 32c. Since there is no need of connecting a wire from the frame body 21 to the movable frame 18, and the wire can be fixed to the frame body 21, wiring reliability can be enhanced.

In the above arrangement, in the case where one of the fixed rollers 26 constituting a roller array is contacted with the placement base 51, or in the case where a part of the movable frame 18 is contacted with the placement base 51, the movable frame 18 is displaced in normal direction to the lower surface of the supporter 17, and one of the landing sensors 32c fixed to the frame body 21 is contacted with a part of the movable frame 18. Thereby, the one landing sensor 32c is actuated. This enables to detect that the lower surface of the supporter 17 has landed onto the placement base 51. In this way, the supporter 17 of the transfer assist device 1 is operable to contact the movable frame 18 with the landing sensor 32c by displacement of the movable frame 18, even if a part of the movable frame 18 is contacted with the placement surface 51 of the wheelchair 53. This enables to detect landing of the supporter 17 onto a placement base having a placement surface of a relatively small surface area.

The movable frame 18 has two extensions 30 near a lead end of the movable frame 18 corresponding to a front portion of the supporter 17. The thickness of each of the extensions 30 can be made small, because there is no need of holding the fixed rollers 26 by the extensions 30. Therefore, the thickness of each of the extensions 30 can be reduced in the direction from the movable frame 18 toward the lead end of the supporter 17. One end of each extension 30 is connected to the movable frame 18, and the other end thereof extends to the proximity of the lead end of the supporter 17. Alternatively, the extensions 30 may be integrally molded with the movable frame 18.

The above arrangement enables to detect that the movable frame 18 has landed onto the placement base 51 even at a position near the lead end of the supporter 17. Since the extension 30 has such a configuration that the thickness thereof is reduced in the direction toward the lead end of the supporter 17, the entire thickness of the lead end of the supporter 17 in the inserting direction of the supporter 17 can be reduced, thereby facilitating an operation of inserting the supporter 17 between the cared person 2 and the placement surface of the placement base 51.

In the following, an operation of using the supporter 17 of the transfer assist device 1 is described referring to FIGS. 13A through 13E.

As shown in FIG. 13A, the transfer assist device 1 is operated to lower the supporter 17 to a position corresponding to an end of the placement base 51 i.e. front side to the cared person 2 to insert the supporter 17 between the cared person 2 and the placement surface of the placement base 51. In performing this operation, the transfer assist device 1 is operated to lower the lead end of the supporter 17 to a position corresponding to the end of the placement base 51 to avoid contact with the cared person 2. In this arrangement, since the transfer assist device 1 has the extensions 30 near the lead end of the supporter 17, the extensions 30 are contactable with the placement surface 51. The movable frame 18 is displaced in normal direction to the lower surface of the supporter 17, as the extensions 30 are contacted with the placement surface 51. The contact of the movable frame 18 with the landing sensor 32c actuates the landing sensor 32c. Since the transfer assist device 1 is operable to detect that the supporter 17 has landed onto the placement surface of the placement base 51, one of a parallel state and an adjusted state between the placement surface and the supporter 17 can be defined and held.

Subsequently, as shown in FIG. 13B, the transfer assist device 1 is operated to insert the supporter 17 between the cared person 2 and the placement surface of the placement base 51. Then, as shown in FIG. 13C, the transfer assist device 1 is operable to contact both of the lead end and the rear end of the movable frame 18 with the placement surface in inserting the supporter 17, and define and hold one of a parallel state and an adjusted state between the tilt of the placement surface and the tilt of the supporter 17.

Then, upon completion of the inserting operation of the supporter 17, as shown in FIG. 13D, the transfer assist device 1 is operated to lift the cared person 2 on the supporter 17.

Subsequently, as shown in FIG. 13E, the transfer assist device 1 is operated to lower the supporter 17, and land the supporter 17 onto the wheelchair 53 so as to transfer the cared person 2 to e.g. the wheelchair 53 whose width is small, as compared with the width of a bed. In performing this operation, even if the length Lb of the supporter 17 corresponding to the distance between the landing sensors 32c is larger than the width La of the wheelchair 53 (Lb>La), contact of a part (central part) of the movable frame 18 at the lower surface of the supporter 17 with the wheelchair 53 displaces the movable frame 18. Then, contact of the movable frame 18 with at least one of the landing sensors 32c fixed near the four corners of the movable frame 18 on the side of the frame body 21 actuates the landing sensor 32c, and detects that the lower surface of the supporter 17 has landed onto the wheelchair 53. Thus, even in the case where the cared person 2 is transferred to the wheelchair 53 whose width is small, as compared with the width of e.g. a bed, there can be detected that the lower surface of the supporter 17 has landed onto the wheelchair 53.

As described above, in a sequence of transferring operations by the transfer assist device 1, as shown in FIG. 13A, it is necessary to operate the transfer assist device 1 to lower the supporter 17 to the end of the placement base 51, insert the supporter 17 between the cared person 2 and the placement surface of the placement base 51 to lift the cared person 2, and to hold the cared person 2 on the supporter 17 to transfer the cared person 2 to a transfer destination. Then, as shown in FIG. 13E, in transferring the cared person 2 to the wheelchair 53, it is necessary to operate the transfer assist device 1 to move the cared person 2 to the center position of the wheelchair 53, and withdraw the supporter 17 from a space between the cared person 2 and the placement base 51 after the supporter 17 has landed. In the transfer assist device 1 having the above arrangement, the tilt of the supporter 17 with respect to the tilt of the placement surface can be adjusted, and landing is detected at any position including the lead portion and the intermediate portion of the supporter 17. Accordingly, the transfer assist device 1 is compatible with a variety of kinds of placement bases 51 different in size and shape.

The landing sensors 32c are fixed near the four corners of the movable frame 18 on the side of the frame body 21. In the transfer assist device 1, since the tilt of the supporter 17 is adjusted with respect to the tilt of the placement surface in X axis direction and Y axis direction, based on the outputs from the landing sensors 32c, the supporter 17 can be smoothly inserted between the placement surface of the placement base 51 and the back of the cared person 2, without a likelihood that the supporter 17 may be abutted against the body of the cared person 2.

As described above, in the transfer assist device 1 in accordance with the second embodiment of the invention, even in the case where the cared person 2 is transferred to a transfer destination such as the wheelchair 53 whose width is small, as compared with the width of e.g. a bed, a part of the movable frame 18 of the supporter 17 e.g. the extensions 30, the fixed rollers 26, or the lower surface of the movable frame 18 (a partial area which makes point, linear, or planar contact with the placement surface at a front portion, an intermediate portion, or a rear portion of the movable frame 18) is contactable with the placement surface of the wheelchair 53. Thereby, even in the case where the supporter 17 has landed onto the wheelchair 53 whose width is small, as compared with the width of e.g. a bed, the transfer assist device 1 is operated in such a manner that contact of the movable frame 18 with the landing sensor 32 by displacement of the movable frame 18 in normal direction to the lower surface of the supporter 17 actuates the landing sensor 32. This enables to detect that the lower surface of the supporter 17 has landed onto the placement surface of the wheelchair 53, and define and hold one of a parallel state and an adjusted state between the placement surface and the supporter 17.

As shown in FIG. 14A, a rear portion of the supporter 17 may be suspended in the air, although the front end of the supporter 17 has landed onto the placement surface of the placement base 51. In this case, whereas the landing sensor 32c near the lead end of the movable frame 18 is actuated by displacement of the lead end of the movable frame 18 in normal direction to the lower surface of the supporter 17, the landing sensor 32 near the rear end of the movable frame 18 is not actuated because the rear end of the movable frame 18 is not displaced. Thereby, the tilted posture of the lower surface of the supporter 17 as shown in FIG. 14A can be detected, based on detection statuses of the four landing sensors 32c provided at the positions corresponding to the four corners of the movable frame 18.

For safety measures, an escapement mechanism may be provided at e.g. a linking portion between the supporter 17 and the arm portion 12 to prevent the cared person 2 from being pressed by the lowering of the supporter 17. In this case, the supporter 17 may be set to a posture as shown in FIG. 14B. Specifically, the transfer assist device 1 may be operated in such a manner that the rear portion of the supporter 17 has landed onto the placement base 51 in a state that the front end of the supporter 17 has not landed onto the placement surface of the placement base 51. In this case, since the rear end of the movable frame 18 is displaced in normal direction to the lower surface of the supporter 17, the landing sensor 32c near the rear end of the supporter 17 is actuated. However, since the lead end of the movable frame 18 is not displaced, the landing sensor 32c near the lead end of the movable frame 17 is not actuated. Thereby, the transfer assist device 1 is operable to detect the posture of the lower surface of the supporter 17 as shown in FIG. 14B, based on detecting statues of the four landing sensors 32c. The transfer assist device 1 includes control operable to suspend an inserting operation, in the case where the posture of the lower surface of the supporter 17 as described above is detected. This avoids a likelihood that the supporter 17 may be abutted against the body of the cared person 2.

The example of using the fixed rollers 26 as a movable guide member of the movable frame 18 has been described as above. Alternatively, a planar board (e.g. a board molded of a resin material having a small friction coefficient) having a small friction coefficient may be mounted on the movable frame 18, in place of the fixed rollers 26. Similarly to the fixed rollers 26, mounting the board on the movable frame 18, with the lower surface of the board being slightly projected from the lower end 33 (see FIG. 11A) reduces a load in inserting the supporter 17 between the cared person 2 and the placement surface of the placement base 51. A clearance between the fixed rollers 26 is not defined by using the board, unlike the arrangement of providing the fixed rollers 26. This enables to detect landing of the supporter 17 at any site on the lower surface thereof. Accordingly, it is possible to detect that the lower surface of the supporter 17 has landed onto the placement base 51, even in the case where a projecting member e.g. a lever for adjusting the tilt of the placement surface of the wheelchair 53 is mounted on the placement surface of the wheelchair 53.

Further alternatively, integrally molding the movable frame 18 and the board enables to detect landing of the supporter 17 at any site on the lower surface thereof, which provides the effect as described above.

### Third Embodiment

In this section, a transfer assist device 9 in accordance with the third embodiment of the invention is described referring to FIG. 15. FIG. 15 is a perspective view showing a basic arrangement of the transfer assist device 9 in accordance with the third embodiment of the invention. Elements in the third embodiment having the same functions as those in the transfer assist device 1 in accordance with the first embodiment are indicated with the same reference numerals, and description thereof is omitted herein.

The transfer assist device 1 in accordance with the first embodiment is operated to insert the single supporter 16 between the placement base 51 on which the cared person 2 is placed, and the cared person 2; and lift the cared person 2 on the lifting surface of the supporter 16 to transfer the cared person 2 to another placement base. In the first embodiment, the supporter 16 is landed on the placement base 51, with the tilt of the supporter 16 being adjusted to the tilt of the placement surface of the placement base 51, and then is inserted between the placement base 51 and the cared person 2.

On the other hand, the transfer assist device 9 in accordance with the third embodiment has multiple supporters 16, and multiple pivot means (joint portions 13 and joint portions 15), and multiple elevating means (leg portions 8) are provided in correspondence to the supporters 16. In this arrangement, the transfer assist device 9 is operable to change the postures of the supporters 16 individually with respect to a complicated-shaped placement base 51 having placement surfaces with two or more tilts.

As shown in FIG. 15, the transfer assist device 9 includes two supporters 16, two joint portions 13 for individually holding the supporters 16 at respective postures of the supporters 16, two arm portions 12, two joint portions 15, two leg portions 8, two holding portions 11 for holding the two legs portions 8, a single control section 110, and two input sections 14.

Similarly to the arrangement shown in FIG. 1, the carer 3 stands between the two supporters 16, operates the input sections 14 with his or her hands, and inputs various commands to move the transfer assist device 9, move the supporters 16, and lift the cared person 2.

In response to the operation commands from the input sections 14, the control section 110 is operable to control the tilts of the two supporters 16 with respect to the placement base 51 (e.g. placement portions 51a and 51b) having placement surfaces with different tilts from each other, respectively, to adjust the tilts of the supporters 16 with respect to the placement surfaces, respectively. In the case where one of the supporters 16 is operated in response to a designation from one of the input sections 14, the control section 110 is operable to control the other of the supporters 16 in cooperation with the one of the supporters 16. For instance, after the supporters 16 are inserted between the placement base 51 and the cared person 2, and the cared person 2 is lifted, the control section 110 is operable to keep the distance between the supporters 16 to a constant value by cooperatively operating the two supporters 16. Thereby, the transfer assist device 9 is operable to securely transfer the cared person 2 in a state that the cared person 2 lies still on the supporters 16. The control of cooperatively operating the two supporters 16 may be executed in inserting the supporters 16 and withdrawing the supporters 16, or exclusively when the cared person 2 is supported on the two supporters 16. For instance, in the case where the supporters 16 are cooperatively operated after the supporters 16 have been inserted between the cared person 2 and the placement surfaces, upon detecting completion of insertions of the two supporters 16, a flag may be set to shift the transfer assist device 9 to a lifting mode. At the lifting mode, the control section 110 may be operable to cooperatively operate the two supporters 16.

The holding unit 11 is an integral unit constructed by linking two holding portions 6 by a linking portion 10. Alternatively, the linking portion 10 may be expandable and contractible to change the distance between the two supporters 16. In this arrangement, individual controls of spatial postures such as the positions and the angles of the supporters 16 can be performed with high precision, thereby enhancing operability of the transfer assist device 9. Thus, the supporters 16 are operable to properly support the cared person 2 at individual body sites such as the head and the legs, depending on the body condition of the cared person 2. This provides an improved transfer function.

As described above, in the transfer assist device 9 in accordance with the third embodiment, tilts of the supporters 16 can be individually adjusted with respect to the placement base 51 having placement surfaces with tilts different from each other, such as a reclining bed. This is advantageous in providing versatile and precise adjustment. For instance, the transfer assist device 9 may be compatible with a placement base 51 having two placement surfaces with tilts different from each other. Also, since the supporters 16 are supported on the holding unit 11 as an integral unit, the rigidity against deformation of the transfer assist device 9 can be increased. Thereby, the distance between the supporters 16 can be retained with precision.

The transfer assist device 9 has the two supporters 16 to lift and transfer the cared person 2 in a state that the cared person 2 lies still. The number of the supporters 16 of the transfer assist device 9 is not limited to two. The number of the supporters 16 can be increased depending on the shape of the placement surface of the placement base 51. Thus, the supporters 16 are provided depending on the complicated shape of the placement surface of the placement base 51. In the case where the number of the supporters 16 is increased, the numbers of the pivot means (joint portions 13 and joint portions 15) for pivotally and individually holding the supporters 16, and elevating means (leg portions 8) may be increased, as required.

In the transfer assist device 9, the supporter 16 recited in the first embodiment is used. Alternatively, the supporter 17 recited in the second embodiment may be used, in place of the supporter 16.

### Fourth Embodiment

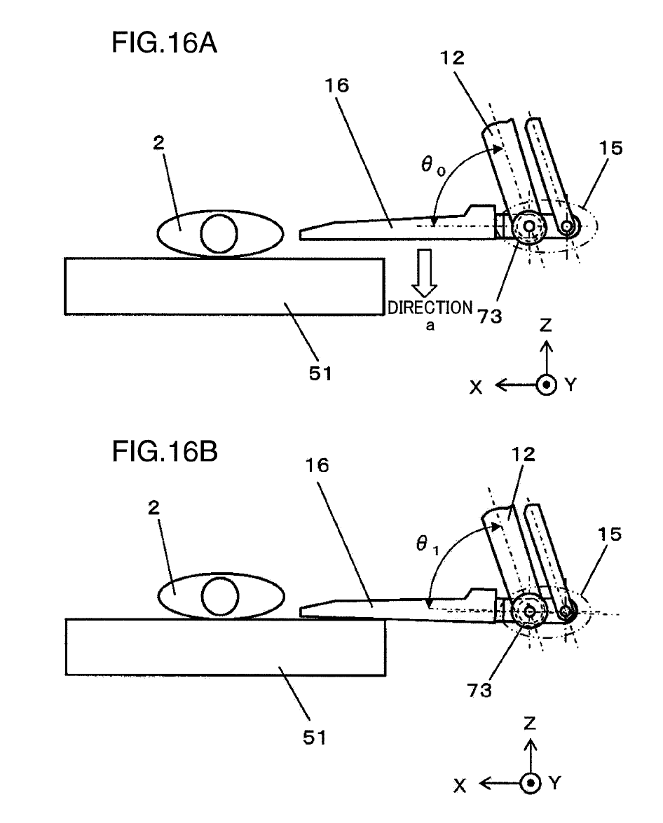

In this section, an application example of a supporter 16 of a transfer assist device 1 in accordance with the fourth embodiment of the invention is described referring to FIGS. 16A and 16B.

FIGS. 16A and 16B are diagrams for describing an application example of a structure of the supporter 16 of the transfer assist device 1 in accordance with the fourth embodiment of the invention. FIG. 16A is a diagram showing a state of the supporter 16 in using the transfer assist device 1 before the supporter 16 is landed. FIG. 1613 is a diagram showing a state of the supporter 16 in using the transfer assist device 1 after the supporter 16 is landed. Elements in the fourth embodiment having the same functions as those in the transfer assist device 1 in accordance with the first embodiment are indicated with the same reference numerals, and description thereof is omitted herein.

As shown in FIG. 16A, the supporter 16 is connected to a joint portion 15 for pivotally moving the supporter 16 about Y axis. The joint portion 15 is linked to an arm portion 12. The arm portion 12 constitutes a linking member of a parallel linking mechanism linked to the joint portion 15. In this arrangement, the supporter 16 is kept horizontal in a state that the supporter 16 is not landed on the placement surface of a placement base 51.

The joint portion 15 has an escapement mechanism (not shown) for freely and pivotally moving the supporter 16 in such a direction as to reduce an angle θ₀; and an angle detecting sensor 73 at a pivot portion around which the joint portion 15 is pivotally moved about Y axis for detecting the angle θ₀ defined by the supporter 16 and the arm portion 12.

An example of the angle detecting sensor 73 is a known encoder. For instance, a rotation potentiometer or a rotation differential transformer may be used.

In the transfer assist device 1, the angle detecting sensor 73 is operable to detect the angle 00 defined by the supporter 16 and the arm portion 12 before the supporter 16 is landed on the placement surface of the placement base 51, and the detected angle θ₀ is stored in a storing section (not shown) of a control section 110.

Then, in the case where the carer 3 manipulates the transfer assist device 1 to lower the supporter 16 downwardly (in a direction of the arrow “a”) in Z axis direction, as shown in FIG. 16B, in response to landing of a part of the supporter 16 onto the placement surface of the placement base 51, the angle detecting sensor 73 is operable to detect that the angle defined by the supporter 16 and the arm portion 12 is changed to an angle θ₁ slightly smaller than the angle θ₀.

Thereby, the transfer assist device 1 is operable to judge whether the supporter 16 is brought to a state θ₀<θ₁ by comparing angle information on the angleθ₀ stored in the storing section with angle information on the angle 0₁. Thus, the transfer assist device 1 is operable to detect whether the supporter 16 has landed onto the placement surface of the placement base 51.

As described above, the transfer assist device 1 in accordance with the fourth embodiment of the invention is operated in such a manner that the angle detecting sensor 73 is operable to detect a change in the angle defined by the supporter 16 and the arm portion 12, and detect landing of supporter 16 onto the placement surface of the placement base 51, based on the change in the angle. This enables to provide substantially the same effect as the effect of the landing sensor 32. Thus, as far as the placement surface of the placement base 51 is flat such as a bed with no tilt in X axis direction, the angle detecting sensor 73 may be used in the transfer assist device 1, in place of the landing sensor 32. Although description is omitted herein, the transfer assist device 1 may be provided with a joint portion 13 for pivotally moving the supporter 16 about X axis, and landing sensors 32a and 32b at side surfaces of the supporter 16, respectively. The modification enables to control the tilt of the supporter 16 in Y axis direction, based on detection results from the landing sensors 32a and 32b.

### Fifth Embodiment

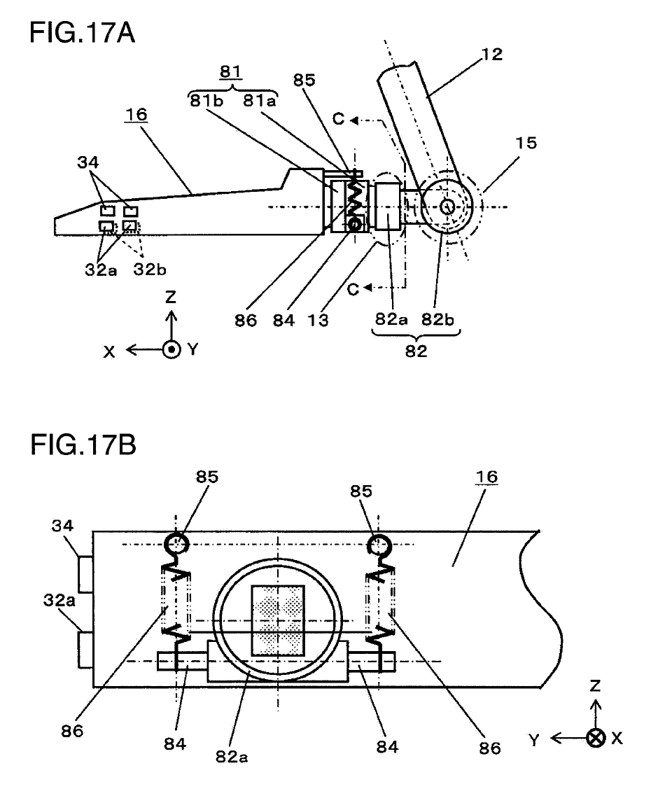

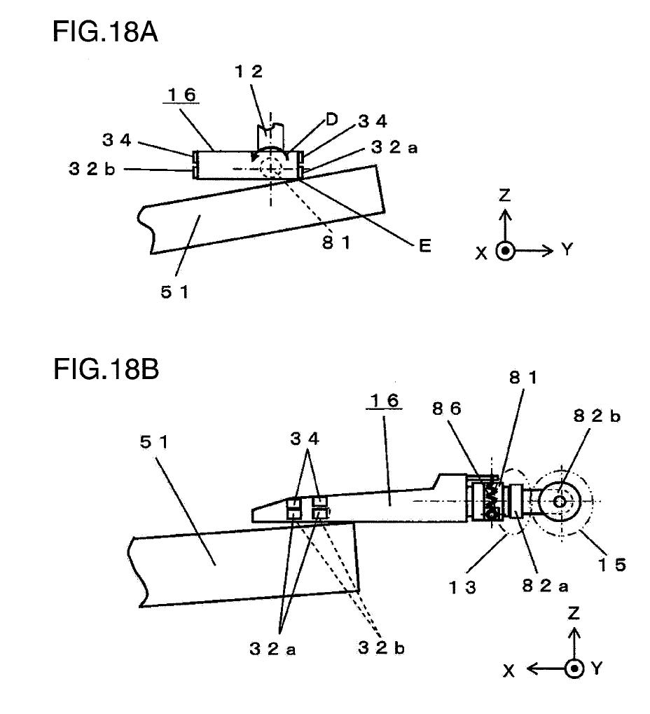

In this section, a supporter 16 of a transfer assist device 1 in accordance with the fifth embodiment of the invention is described referring to FIGS. 17A and 17B, and FIGS. 18A and 18B.

In the fifth embodiment, there is described an automatic tilt adjusting function of adjusting the tilt of the supporter 16, in the case where the placement surface of a placement base 51 such as a bed is tilted both in Y axis direction and X axis direction.

FIGS. 17A and 17B, and FIGS. 18A and 18B are diagrams for describing an application example of a structure of the supporter 16 of the transfer assist device 1 in accordance with the fifth embodiment of the invention. FIG. 17A is a side view showing the structure of the supporter 16. FIG. 17B is an enlarged sectional view taken along the line C-C in FIG. 17A. FIG. 18A is a front view showing a positional relation between the supporter 16 and the placement base 51. FIG. 18B is a side view showing a state that the supporter 16 is contacted with the placement base 51. Elements in the fifth embodiment having the same functions as those in the transfer assist device 1 in accordance with the first embodiment are indicated with the same reference numerals, and description thereof is omitted herein.

The structure for linking the supporter 16 to an arm portion 12 is described. As shown in FIGS. 17A and 17B, the supporter 16 is linked to the arm portion 12 via a joint portion 13 and a joint portion 15. The joint portion 13 has a clutch portion 81 such as an electromagnetic clutch.

The joint portions 13 and 15 have drive motors 82 in correspondence to respective axes thereof to pivotally move the supporter 16 about X axis and Y axis, respectively. The drive motor 82 for pivotally moving the joint portion 13 about X axis is referred to a drive motor 82a, and the drive motor 82 for pivotally moving the joint portion 15 about Y axis is referred to a drive motor 82b. The drive motor 82 (82a, 82b) may have a speed reducer for reducing the rotation number and increasing the torque.

The clutch portion 81 has a drive shaft portion 81a and a driven shaft portion 81b. The drive shaft portion 81a has two spring hook portions 84 projecting outwardly in Y axis direction. The supporter 16 has two spring hook portions 85 projecting outwardly in X axis direction at side surfaces of the joint portion 13. Tension springs 86 each is provided between the spring hook portions 84 and 85 on the same side. The two tension springs 86 have an automatic tilt adjusting function of retaining the tilt of the supporter 16 at a pivot position fixed by the drive motor 82a, in pivotally moving the supporter 16 about X axis. The tension springs 86 may be a resilient member such as a rubber member or a spring.

When the clutch portion 81 is turned off (not actuated), the supporter 16 is disengaged from the drive motor 82a. Thereby, the supporter 16 is freely and pivotally moved about X axis, and is pivotally moved against a resilient force of the two tension springs 86 provided at both sides of the clutch portion 81, viewed from the drive motor 82a. Thereby, the tilt of the supporter 16 is kept in a predetermined pivot range with respect to the tilt of the supporter 16 at the pivot position fixed by the drive motor 82a.

On the other hand, when the clutch portion 81 is turned on (actuated), the supporter 16 is fixed to the joint portion 13, and pivotally moved about X axis in accordance with rotation of the drive motor 82a. In the transfer assist device 1, e.g. a joint driver 114 is operable to pivotally move the supporter 16 about X axis using the drive motor 82a.

Next, an operation of adjusting the tilt of the supporter 16 is described. As shown in FIG. 18A, in landing the supporter 16 onto the placement surface of the placement base 51, the clutch portion 81 is turned off (not actuated) in a state that the supporter 16 is away from the placement base 51. In performing this operation, the posture of the supporter 16 is retained by the two tension springs 86. Then, in response to contact of an end portion “E” of the supporter 16 with the placement surface of the placement base 51 in width direction of the supporter 16, the supporter 16 is pivotally moved about X axis against a resilient force of the tension springs 86. Further, in lowering the supporter 16 downwardly in Z axis direction, the supporter 16 is pivotally moved in the direction of the arrow “D”, and is aligned in parallel to the placement surface of the placement base 51. In response to turning on (actuating) of the clutch portion 81 in this state, the tilt of the supporter 16 can be fixed.

Subsequently, as shown in FIG. 18B, in the case where there is a tilt difference between the placement surface of the placement base 51 and the lower surface of the supporter 16 in X axis direction, the carer 3 inputs designation information to an input section 14 so as to actuate landing sensors 32a and 32b, drive the drive motor 82b, and pivotally move the supporter 16 about Y axis.

As described above, the transfer assist device 1 in accordance with the fifth embodiment of the invention is operable to freely and pivotally move the supporter 16 about X axis by turning off the clutch portion 81 and disengaging the supporter 16 from the drive motor 82a. This enables to smoothly adjust the tilt of the supporter 16 with respect to the placement surface of the placement base 51. Also, the transfer assist device 1 is operable to fix the tilt of the supporter 16 by turning on the clutch portion 81 in response to alignment of the lower surface of the supporter 16 in parallel to the placement surface of the placement base 51. Further, in the case where there is a tilt difference between the placement surface of the placement base 51 and the lower surface of the supporter 16 in X axis direction, the carer 3 is allowed to input designation information to the input section 14 so as to actuate the landing sensors 32a and 32b, drive the drive motor 82b, and adjust the tilt of the supporter 16 about Y axis. Thereby, the carer 3 is allowed to adjust the tilt of the placement surface of the placement base 51 such as a bed with respect to the tilt of the supporter 16 both in Y axis direction and X axis direction.

Also, the movement of the supporter 16 is controlled by the tension springs 86 and the clutch portion 81, and the tilt of the supporter 16 is adjusted depending on the figure and/or the posture of the cared person 2. Accordingly, the carer 3 is allowed to smoothly transfer the cared person 2.

### Sixth Embodiment

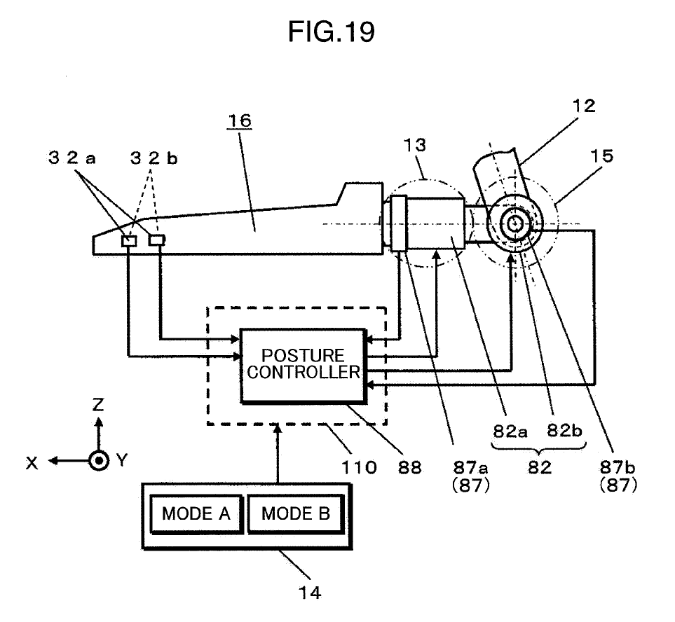

In this section, a supporter 16 of a transfer assist device 1 in accordance with the sixth embodiment of the invention is described referring to FIG. 19.

In the sixth embodiment, an example of retaining the tilt of the supporter 16 by using a drive motor is described.

FIG. 19 is a side view for describing an application example of a structure of the supporter 16 of the transfer assist device 1 in accordance with the sixth embodiment of the invention. Elements in the sixth embodiment having the same functions as those in the transfer assist device 1 in accordance with the first embodiment are indicated with the same reference numerals, and description thereof is omitted herein.

As shown in FIG. 19, a joint portion 13 and a joint portion 15 for holding the supporter 16 are provided with drive motors 82 and rotation angle detectors 87, respectively. A control section 110 has a posture controller 88.

The rotation angle detector 87 for detecting rotation about X axis is referred to as a rotation angle detector 87a, and the rotation angle detector 87 for detecting rotation about Y axis is referred to as a rotation angle detector 87b.

The posture controller 88 is a part of the control section 110, and is actuated in response to designation information from an input section 14. In response to input of designation information such as “TILT RETAINING MODE” from the input section 14, the posture controller 88 actuates the drive motor 82a, 82b to pivotally move the joint portion 13, 15 about X axis, Y axis, based on information from the rotation angle detector 87 (87a, 87b) to control the tilt of the supporter 16.

In retaining the tilt of the supporter 16, the supporter 16 may be controllably tilted in a predetermined allowable range. For instance, the input section 14 may include setting modes such as “MODE A” where the allowable range of the tilt of the supporter 16 is large, and “MODE B” where the allowable range of the tilt of the supporter 16 is small. Further alternatively, a driving force for use in controlling the allowable range of the tilt of the supporter 16 or the tilt of the supporter 16 may be adjusted stepwise or sequentially by using a slidable input device.

As described above, the transfer assist device 1 in accordance with the sixth embodiment of the invention is operated in such a manner that the posture controller 88 is operable to actuate the drive motor 82a, 82b, based on designation information such as “TILT RETAINING MODE” to be inputted from the input section 14, and information from the rotation angle detector 87 (87a, 87b) so as to pivotally move the joint portion 13, 15 about X axis, Y axis, whereby the tilt of the supporter 16 can be retained.

Also, the input section 14 is provided with “MODE A” where the allowable range of the tilt of the supporter 16 is large, and “MODE B” where the allowable range of the tilt of the supporter 16 is small. This enables to control the tilt of the supporter 16 so that the allowable range of the tilt of the supporter 16 is changed depending on the setting mode.

Further, the driving force for use in controlling the allowable range of the tilt of the supporter 16 or the tilt of the supporter 16 can be adjusted stepwise or sequentially by using the slidable input device. This enables to finely control the posture of the cared person 2, and provide a universally usable transfer assist device having an automatic tilt adjusting function.

### Seventh Embodiment

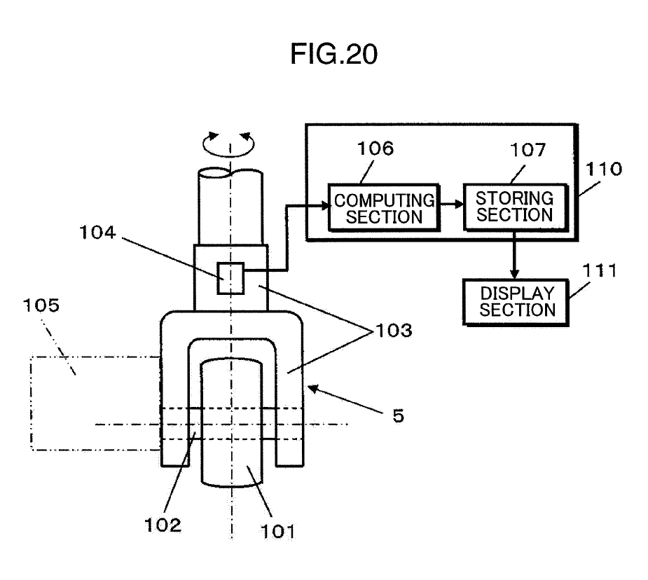

In this section, another landing detection method with use of a transfer assist device 1 in accordance with he seventh embodiment of the invention is described referring to FIG. 20. Specifically, an example of a method for detecting landing with use of multiple load sensors is described.

FIG. 20 is a front view showing a structure example of a wheel 5 of the transfer assist device 1 in accordance with the seventh embodiment of the invention. Elements in the seventh embodiment having the same functions as those in the transfer assist device 1 in accordance with the first embodiment are indicated with the same reference numerals, and description thereof is omitted herein.

As shown in FIG. 20, the wheel 5 includes a roller 101, a roller shaft 102, a housing 103, and a load sensor 104. The wheel 5 is provided in plural number, and the wheels 5 are fixed or pivotally mounted on holding portions 6 (see e.g. FIG. 3). The load sensor 104 is mounted on the housing 103. The wheel 5 is linked to a drive source 105 via a speed reducer, and is freely rotatable.

A control section 110 includes a computing section 106 for computing the centroid position of the transfer assist device 1, and a storing section 107 for storing a computation result.

The computing section 106 is operable to compute the centroid position of the transfer assist device 1 at a predetermined time interval, based on output signals from the load sensors 104; and successively store computation results into the storing section 107. The computing section 106 is operable to compute a differential value of the computation results stored in the storing section 107, and detect whether the supporter 16 has landed onto the placement surface of a placement base 51, based on the differential value. In other words, the load sensors 104 serve as landing detecting means.

As described above, the transfer assist device 1 in accordance with the seventh embodiment of the invention is operable to detect a change in the centroid position of the transfer assist deice 1 in operation, based on output signals from the load sensors 104, and detect whether the supporter 16 has landed onto the placement surface of the placement base 51 based on the change. Further, the carer 3 is allowed to recognize the centroid posture of the transfer assist device 1 during manipulation by detecting the centroid position of the transfer assist device 1. This enables to avoid a dangerous posture of the transfer assist device 1, thereby enhancing safe use of the transfer assist device 1.

### Eighth Embodiment

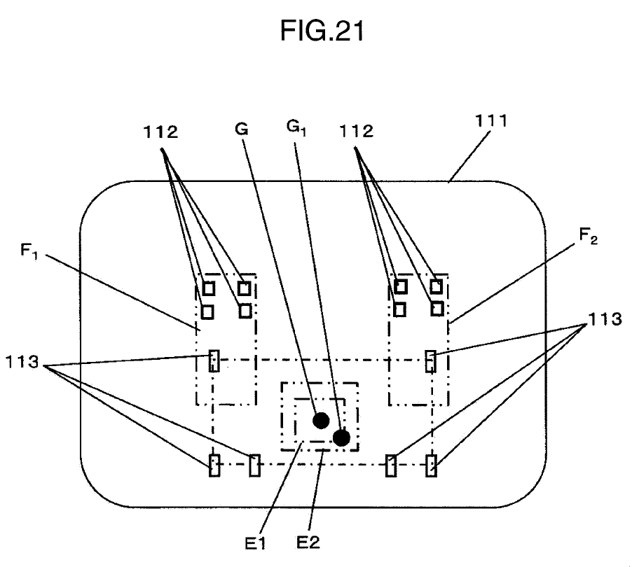

In this section, an application example in the case where a transfer assist device 1 in accordance with the eighth embodiment of the invention is provided with a display section 111 is described referring to FIG. 21.

FIG. 21 is a diagram for describing an arrangement example of the display section 111 of the transfer assist device 1 in accordance with the eighth embodiment of the invention. Elements in the eighth embodiment having the same functions as those in the transfer assist device 1 in accordance with the first embodiment are indicated with the same reference numerals, and description thereof is omitted herein. In this embodiment, there is described an arrangement example of the display section 111, wherein the cared person 2 is transferred by using two transfer assist devices 1 in cooperation with each other.

As shown in FIG. 21, the display section 111 is operable to project and display arrangement positions 113 of rollers 101, a centroid position G of the transfer assist device 1, and a centroid position G1 of the transfer assist device 1 in landing the supporter 16 onto the placement surface of a placement base 51. The centroid position G and the centroid position G1 may be the centroid positions calculated in the seventh embodiment. Outer perimeter frames F1 and F2 respectively indicating the positions of the two supporters 16 are displayed on the display section 111.

An example of the display section 111 may be a display device incorporated with a liquid crystal display or an organic EL (electroluminescence) display. Use of the display section 111 allows the carer 3 to recognize whether the supporter 16 has landed onto the placement surface of the placement base 51, based on a change in the positional relation between the centroid position G and the centroid position G1 displayed on the display section 111, in landing the supporter 16 onto the placement surface of the placement base 51. The display section 111 may be provided on one of the two transfer assist devices 1.

The centroid position G1 in a landing check frame (E1, E2) indicates that the supporter 16 has landed onto the placement surface of the placement base 51 with a proper pressure. The landing check frame El is used, in the case where there is a single supporter 16 to be landed onto the placement surface of the placement base 51, and the landing check frame E2 is used, in the case where there are two supporters 16 to be landed onto the placement surface of the placement base 51. The outer area of the landing check frame (E1, E2) to be displayed on the display section 111 corresponds to a dangerous posture area where the transfer assist device 1 may be tipped over, and the inner area thereof corresponds to a safe posture area where the transfer assist device 1 is safely used.

As described above, in the transfer assist device 1 in accordance with the eighth embodiment of the invention, the carer 3 is allowed to recognize whether the supporter 16 has landed onto the placement surface of the placement base 51, based on a change in the positional relation between the centroid position G and the centroid position G1 displayed on the display section 111.

Further, the carer 3 is allowed to easily recognize whether the transfer assist device 1 is set in a safe posture, based on display positions of the centroid positions G and G1 displayed on the display section 111. This avoids a likelihood that the transfer assist device 1 may be set in a dangerous posture where the transfer assist device 1 is tipped over, thereby enhancing safe use of the transfer assist device 1.

Alternatively, notice/display sections 112 may be provided within the outer perimeter frames F1 and F2 respectively indicating the positions of the supporters 16 to display an operated state of a landing sensor 32 on a coordinate system defined based on the arrangement position of the landing sensor 32.

As described above, the transfer assist devices 1 and the transfer assist device 9 embodying the invention have been described in the case where the carer 3 transfers the cared person 2. As far as the cared person 2 is a human, the invention may be applied to any person including a physically disabled or challenged person having difficulty in moving/walking. The transfer assist devices 1 and the transfer assist device 9 of the invention are advantageous in lifting the cared person 2 from the placement surface of a placement base, and transferring the cared person 2 to another placement base.

Further alternatively, the transfer assist device 1 may be provided with a camera or a like device to allow the carer 3 to recognize the supporter 16, 17 based on image information, and control the position and the posture of the supporter 16, 17.

### SUMMARY OF THE EMBODIMENTS

In this section, a summary of the embodiments of the invention is described.

(1) As described above, even in the case where the placement surface of the placement base on which a human body is placed is not horizontal, e.g., a surface of a bed is tilted, operating at least one of pivot means and elevating means in inserting the supporter between the human body and the placement surface enables to define and hold at least one of a parallel state and an adjusted state between the placement surface and the supporter, based on outputs from multiple landing detecting means. Accordingly, the transfer assist devices of the embodiments are advantageous in automatically adjusting the position and the angle of the supporter with respect to the tilt of the placement surface of the placement base on which a human such as a cared person is placed in transferring the cared person. Thus, the arrangement allows the carer to smoothly lift and transfer the cared person from the placement base, without especially paying attention to a positional relation between the placement surface and the transfer assist device.

(2) Preferably, the multiple landing detecting means may be disposed on the lower surface of the supporter at positions away from each other in a direction orthogonal to a pivot axis of each of the pivot means. In lowering the supporter from above the placement surface toward the placement surface by the elevating means, in the case where one of the multiple landing detecting means disposed in the direction orthogonal to the pivot axis of each of the pivot means has detected the landing onto the placement surface, the control means may be operable to move the elevating means so as to retain a height of the one landing detecting means that has detected the landing with respect to the placement surface, while pivotally moving the pivot means; in the case where two or more of the multiple landing detecting means have detected the landing, the control means may be operable to terminate the pivotal movement of the pivot means; and at a point of time when the pivotal movements of all the pivot means are terminated, the control means may be operable to suspend the lowering operation of the elevating means.

The above arrangement enables to land and hold the supporter in parallel to the placement surface by the multiple landing detecting means and the pivot means. Thereby, the tilt of the lower surface of the supporter can be aligned in parallel to the placement surface having a tilt different from the tilt of the lower surface of the supporter.

(3) Preferably, the transfer assist device may further include supporter inserting means for moving the supporter in an inserting direction thereof During the operation of inserting the supporter between the human body and the placement surface by the supporter inserting means, in the case where none of the multiple landing detecting means has detected the landing, the control means may be operable to lower the elevating means; in the case where one of the outputs from the multiple landing means disposed in the direction orthogonal to the pivot axis of each of the pivot means is larger than a predetermined range, the control means may be operable to pivotally move the pivot means in a direction of moving the landing detecting means whose output is larger than the predetermined range in a direction away from the placement surface; and in the case where one of the outputs from the multiple landing means is smaller than the predetermined range, the control means may be operable to pivotally move the pivot means in a direction of moving the landing detecting means whose output is smaller than the predetermined range in a direction toward the placement surface to keep output statuses of the multiple landing detecting means in the predetermined range.

In the above arrangement, in inserting the supporter, the output statuses of the multiple landing detecting means can be kept in the predetermined range. Accordingly, in inserting the supporter, the supporter can be brought to a predetermined contact state with respect to the placement surface.

(4) Preferably, the multiple landing detecting means each may be constituted of a pressure sensor to determine a landing state of the supporter based on a judgment as to whether a contact pressure of the pressure sensor with respect to the placement surface falls in a predetermined pressure range.

The above arrangement enables to determine a landing state of the supporter with respect to the placement surface, based on information relating to the contact pressure. Thereby, the supporter can be landed onto the placement surface by controlling the contact pressure. Also, the above arrangement enables to avoid tipping over or breakage of the transfer assist device, or breakage of the placement base resulting from a reaction force due to erroneous contact of the supporter with the placement surface.

(5) Preferably, the predetermined pressure range may be a pressure range of the placement surface to be applied from the human body at an inserted site of the supporter. In this arrangement, setting the predetermined pressure range substantially equal to the pressure range of the placement surface to be applied from the human body at the inserted site of the supporter enables to make a sinking amount of the human body with respect to the placement surface substantially equal to a sinking amount of the supporter at the inserted site. This enables to suppress generation of a gap resulting from a difference in the sinking amount at the inserted site of the supporter, and smoothly insert the supporter.

(6) Preferably, the transfer assist device may further include a movable guide member constructed to be displaceable in a normal direction to the lower surface of the supporter, wherein the multiple landing detecting means are disposed on the lower surface of the supporter, and are operable to determine a landing state of the supporter by detecting a displacement of the movable guide member.

In the above arrangement, since the movable guide member is displaced depending on the contact pressure between the placement base and the supporter, landing of the supporter onto the upper surface of the placement base can be detected by displacement of the movable guide member.

(7) Preferably, the movable guide member may be a movable frame displaceably supported on a frame body of the supporter, and the movable frame may be displaced in the normal direction to the lower surface of the supporter by a contact pressure with respect to the placement surface. In this arrangement, for instance, contact of a part of the movable frame with the placement surface displaces the movable frame in the normal direction to the lower surface of the supporter. Then, the contact of the movable frame with the placement surface actuates the landing detecting means. Thus, landing can be detected by an operation of the movable frame having a relatively large surface area. Accordingly, even in the case where an intermediate portion on the lower surface of the supporter is lowered onto the placement surface of a wheelchair having a relatively small width, as compared with a bed, in transferring the cared person to the wheelchair, the landing can be detected by the landing detecting means.

(8) Preferably, the transfer assist device may further include a resilient member, disposed between the frame body and the movable frame, for urging the movable frame downwardly. In this arrangement, since the movable frame is supported on the frame body to be urged downwardly in normal direction to the lower surface of the supporter, there can be suppressed displacement of the movable frame due to tilt or vibration of the supporter, or an external force to be applied to the supporter, thereby preventing erroneous detection by the landing detecting means.

(9) Preferably, the multiple landing detecting means may be disposed on a frame body of the supporter. This arrangement enables to detect landing of the supporter by the peripheral part of the supporter, thereby enhancing detection precision on the posture of the supporter in landing. Also, since a wire can be connected to the frame body serving as the main body of the transfer assist device, wiring is easy. Further, since there is no need of connecting a wire from the frame body to the movable guide member, and the wire can be fixed to the frame body, wiring reliability can be enhanced.

(10) Preferably, the multiple landing detecting means may be disposed at least near both ends on the lower surface of the supporter at a front portion in an inserting direction of the supporter. In this arrangement, the landing detecting means disposed near the both ends on the lower surface at the front portion of the supporter can determine a landing state of the supporter in inserting the supporter. This arrangement is advantageous in detecting the posture of the supporter at the lead end (front portion) of the supporter in inserting the supporter, thereby realizing smooth insertion and landing.

(11) Preferably, the pivot means may include first pivot means operable to pivotally move about an axis in alignment with an inserting direction of the supporter, and the multiple landing detecting means may be at least two landing detecting means. In this arrangement, the single pivot means operable to pivotally move about the axis in alignment with the inserting direction of the supporter, and the two landing detecting means enable to control the posture of the supporter. Accordingly, this arrangement is advantageous in controlling the posture of the supporter with respect to two-dimensional tilt of the placement surface.

(12) Preferably, the pivot means may include first pivot means operable to pivotally move about an axis in alignment with an inserting direction of the supporter, and second pivot means operable to pivotally move about an axis orthogonal to the axis of the first pivot means within the lower surface of the supporter, and the multiple landing detecting means may be at least three landing detecting means. In this arrangement, the two pivot means operable to pivotally move about the two axes of the supporter orthogonal to each other, and the three landing detecting means enable to control the posture of the supporter. Accordingly, this arrangement is advantageous in controlling the posture of the supporter with respect to three-dimensional tilt of the placement surface.

(13) A transfer assist device according to another aspect of the invention includes: a supporter operable to be inserted between a placement surface of a placement base and a human body placed on the placement surface, and lift the human body; one or more pivot means for performing at least one of changing and adjusting a posture of the supporter; landing detecting means for detecting whether a lower surface of the supporter has landed onto an upper surface of the placement surface; elevating means for moving the supporter up and down; and control means for controlling the elevating means based on an output from the landing detecting means, wherein the landing detecting means is disposed near a center on the lower surface of the supporter in a width direction of the supporter orthogonal to an inserting direction of the supporter, the transfer assist device further includes a clutch disposed between the supporter and the pivot means, and a resilient member for resiliently supporting the supporter to pivotally move the supporter relative to the pivot means, and in lowering the supporter from above the placement surface by the elevating means, the control means controls the clutch and the elevating means to lower the supporter, while disengaging the clutch, until the landing of the supporter onto the placement surface is detected by the landing detecting means; and terminate the lowering of the supporter, while engaging the clutch, upon detecting the landing of the supporter by the landing detecting means.

The above arrangement enables to pivotally move the supporter in a range defined by the resilient member in moving the supporter up and down; detect whether the supporter has landed by the landing detecting means; and fixedly support the supporter by the pivot means at a landing position by engagement of the clutch to suspend the pivotal movement of the supporter. In this arrangement, the spatial posture of the supporter can be controlled and held by providing the single landing detecting means. This is advantageous in reducing the number of the landing detecting means. Also, the resilient member is operable to constrain the supporter from freely and pivotally moving by disengagement of the clutch. Further, the tilt of the supporter can be adjusted depending on the figure and/or the posture of the cared person.

(14) Preferably, the supporter may be provided in plural number, the pivot means and the elevating means may be each provided in plural number corresponding to the supporters, the multiple landing detecting means may be operable to detect whether the lower surfaces of the supporters have landed onto the placement surface of the placement base, respectively, and the control means may control the pivot means or the elevating means, based on the outputs from the multiple landing detecting means.

In the above arrangement, the transfer assist device is easily compatible with a placement base having placement surfaces with tilts different from each other by using the supporters. This is advantageous in providing versatile and precise adjustment. For instance, the transfer assist device is compatible with a complicated-shaped placement base having placement surfaces with three or more tilts.

(15) A transfer assist device with a multi-supporter mechanism according to yet another aspect of the invention includes: a plurality of the transfer assist devices having one of the above arrangements, and a control device for controlling the transfer assist devices in cooperation with each other, wherein an angle of the supporter of each of the transfer assist devices is adjusted with respect to a tilt angle of the placement surface.

In the above arrangement, even if the placement base has placement surfaces with tilts different from each other, the transfer assist device with a multi-supporter mechanism is compatible with the tilts of the placement surfaces of the placement base by using the supporters. Thus, the transfer assist device with a multi-supporter mechanism is flexibly compatible with placement bases having different shapes. For instance, the transfer assist device with a multi-supporter mechanism is compatible with a complicated-shaped placement base having placement surfaces with three or more tilts.

(16) Preferably, in the transfer assist device with the multi-supporter mechanism, the transfer assist devices may be constructed into a unit by a linking portion for linking the transfer assist devices. This enables to reinforce the cooperative movement of the transfer assist devices, and increase the strength of the transfer assist device with a multi-supporter mechanism against deformation. Thereby, the distance between the supporters can be retained with precision.

As described above, even in the case where the tilt of the placement surface of the placement base on which a human body is placed is not horizontal, the embodiments of the invention are advantageous in providing a transfer assist device and a transfer assist device with a multi-supporter mechanism capable of smoothly lifting and transferring the human body from the placement base, while suppressing the work load to the carer.

### INDUSTRIAL APPLICABILITY

As described above, the invention is advantageous in inserting a supporter between a placement base on which a cared person to be transferred is placed, and the cared person, and lifting the cared person on a lifting surface of the supporter to transfer the cared person, and particularly advantageous in allowing a carer to smoothly lift and transfer the cared person from the placement base, even if the tilt of the placement surface of the placement base on which the cared person is placed is not horizontal. Accordingly, the invention is useful as a transfer assist device, a transfer assist device with a multi-supporter mechanism, a nursing robot system incorporated with the transfer assist system, and a like system.

1. A transfer assist device comprising:
a supporter operable to be inserted between a placement surface of a placement base and a human body placed on the placement surface, and lift the human body;
one or more pivot portion means for performing at least one of changing and adjusting a posture of the supporter;
multiple landing detecting portion for detecting whether a lower surface of the supporter has landed onto the placement surface;
elevating portion for moving the supporter up and down; and
control section for controlling the pivot portion or the elevating portion to define and hold at least one of a parallel state and an adjusted state between the placement surface and the supporter, based on outputs from the multiple landing detecting portion.

2. The transfer assist device according to claim 1, wherein
the multiple landing detecting portion are disposed on the lower surface of the supporter at positions away from each other in a direction orthogonal to a pivot axis of each of the pivot portion,
in lowering the supporter from above the placement surface toward the placement surface by the elevating portion,
in the case where one of the multiple landing detecting portion disposed in the direction orthogonal to the pivot axis of each of the pivot portion has detected the landing onto the placement surface, the control section is operable to move the elevating portion so as to retain a height of the one landing detecting portion that has detected the landing with respect to the placement surface, while pivotally moving the pivot portion,
in the case where two or more of the multiple landing detecting portion have detected the landing, the control section is operable to terminate the pivotal movement of the pivot portion, and
at a point of time when the pivotal movements of all the pivot portion are terminated, the control section is operable to suspend the lowering operation of the elevating portion.

3. The transfer assist device according to claim 1, further comprising supporter inserting portion for moving the supporter in an inserting direction thereof, wherein
during the operation of inserting the supporter between the human body and the placement surface by the supporter inserting portion,
in the case where none of the multiple landing detecting portion has detected the landing, the control section is operable to lower the elevating portion,
in the case where one of the outputs from the multiple landing portion disposed in the direction orthogonal to the pivot axis of each of the pivot portion is larger than a predetermined range, the control section is operable to pivotally move the pivot portion in a direction of moving the landing detecting portion whose output is larger than the predetermined range in a direction away from the placement surface, and
in the case where one of the outputs from the multiple landing portion is smaller than the predetermined range, the control section is operable to pivotally move the pivot portion in a direction of moving the landing detecting portion whose output is smaller than the predetermined range in a direction toward the placement surface,
to keep output statuses of the multiple landing detecting portion in the predetermined range.

4. The transfer assist device according to claim 1, wherein
the multiple landing detecting portion are each constituted of a pressure sensor to determine a landing state of the supporter based on a judgment as to whether a contact pressure of the pressure sensor with respect to the placement surface falls in a predetermined pressure range.

5. The transfer assist device according to claim 4, wherein
the predetermined pressure range is a pressure range of the placement surface to be applied from the human body at an inserted site of the supporter.

6. The transfer assist device according to claim 1, further comprising a movable guide member configured to be displaceable in a normal direction to the lower surface of the supporter, wherein
the multiple landing detecting portion are disposed on the lower surface of the supporter, and are operable to detect whether the supporter has landed by detecting a displacement of the movable guide member.

7. The transfer assist device according to claim 6, wherein
the movable guide member is a movable frame displaceably supported on a frame body of the supporter, and
the movable frame is displaced in the normal direction to the lower surface of the supporter by a contact pressure with respect to the placement surface.

8. The transfer assist device according to claim 7, further comprising
a resilient member, disposed between the frame body and the movable frame, for urging the movable frame downwardly.

9. The transfer assist device according to claim 1, wherein
the multiple landing detecting portion are disposed on the frame body of the supporter.

10. The transfer assist device according to claim 1, wherein
the multiple landing detecting portion are disposed at least near both ends on the lower surface of the supporter at a front portion in an inserting direction of the supporter.

11. The transfer assist device according to claim 1, wherein
the pivot portion includes first pivot portion operable to pivotally move about an axis in alignment with an inserting direction of the supporter, and
the multiple landing detecting portion are at least two landing detecting portion.

12. The transfer assist device according to claim 1, wherein
the pivot portion includes first pivot portion operable to pivotally move about an axis in alignment with an inserting direction of the supporter, and second pivot portion operable to pivotally move about an axis orthogonal to the axis of the first pivot portion within the lower surface of the supporter, and
the multiple landing detecting portion are at least three landing detecting portion.

13. A transfer assist device comprising:
a supporter operable to be inserted between a placement surface of a placement base and a human body placed on the placement surface, and lift the human body;
one or more pivot portion for performing at least one of changing and adjusting a posture of the supporter;
landing detecting portion for detecting whether a lower surface of the supporter has landed onto an upper surface of the placement surface;
elevating portion for moving the supporter up and down; and
control section for controlling the elevating portion based on an output from the landing detecting portion, wherein
the landing detecting portion is disposed near a center on the lower surface of the supporter in a width direction of the supporter orthogonal to an inserting direction of the supporter,
the transfer assist device further includes a clutch disposed between the supporter and the pivot portion, and a resilient member for resiliently supporting the supporter to pivotally move the supporter relative to the pivot portion, and
in lowering the supporter from above the placement surface by the elevating portion, the control section controls the clutch and the elevating portion to lower the supporter, while disengaging the clutch, until the landing of the supporter onto the placement surface is detected by the landing detecting portion, and terminate the lowering of the supporter, while engaging the clutch, upon detecting the landing of the supporter by the landing detecting portion.

14. The transfer assist device according to claim 1, wherein
the supporter is provided in plural number,
the pivot portion and the elevating portion are each provided in plural number corresponding to the supporters,
the multiple landing detecting portion are operable to detect whether the lower surfaces of the supporters have landed onto the placement surface of the placement base, respectively, and
the control section controls the pivot portion or the elevating portion, based on the outputs from the multiple landing detecting portion.

15. A transfer assist device with a multi-supporter mechanism, comprising:
a plurality of the transfer assist devices of claim 1, and
a control device for controlling the transfer assist devices in cooperation with each other, wherein
an angle of the supporter of each of the transfer assist devices is adjusted with respect to a tilt angle of the placement surface.

16. The transfer assist device with the multi-supporter mechanism according to claim 15, wherein
the transfer assist devices are constructed into a unit by a linking portion for linking the transfer assist devices.
